(19) United States
(12) Patent Application Publication
(10) Pub. No.: US 2008/0109225 A1
(43) Pub. Date: May 8, 2008

(54) Speech Synthesis Device, Speech Synthesis Method, and Program

(75) Inventor: Yasushi Sato, Fukuoka (JP)

Correspondence Address: ERIC ROBINSON, PMB 955, 21010 SOUTHBANK ST., POTOMAC FALLS, VA, 20165, US

(73) Assignee: KABUSHIKI KAISHA KENWOOD, Hachiouji-shi (JP)

(21) Appl. No.: 11/885,989

(22) PCT Filed: Mar. 10, 2006
(86) PCT No.: PCT/JP06/05305

§ 371 Date: Sep. 10, 2007

(30) Foreign Application Priority Data
Mar. 11, 2005 (JP) 2005-069787

(51) Int. Cl. G10L 13/08

(52) U.S. Cl. 704/260; 704/E13.013

(57) ABSTRACT

A speech piece editing section (5) retrieves speech piece data on a speech piece the read of which matches that of a speech piece in a fixed message from a speech piece database (7) and converts the speech piece so as to match the speed specified by utterance speed data. The speech piece editing section (5) predicts the prosody of a fixed message and selects an item of the retrieved speech piece data most matching each speech piece of the fixed message one by one according to the prosody prediction results. However, if the proportion of the speech piece corresponding to the selected item of the speech piece data does not reach a predetermined value, the selection is cancelled. Concerning the speech piece for which selection is not made, waveform data representing the waveform of each unit speech is supplied to a sound processing section (41). The selected speech piece data and the supplied waveform data are interconnected thereby to create data representing a synthesized speech. Thus, a speech synthesis device for quickly producing a synthesized speech without any uncomfortable feeling with a simple structure is provided.

### TECHNICAL FIELD

The present invention relates to a speech synthesis device, a speech synthesis method and a program for the same.

### BACKGROUND ART

As a method for synthesizing a speech, a method called a record editing method is known. The record editing method is used in a speech assisting system at a station, an on-vehicle navigation device and the like.

The record editing system is such a method for associating a word with speech data that represents a speech of reading the word in advance, separating a sentence to be subjected to the speech synthesis into words, and then obtaining the speech data associated with the words and combining the speech data (for example, see Japanese Patent Application Laid-Open No. 10-49193).

### DISCLOSURE OF THE INVENTION

If pieces of speech data are simply combined with each other, the synthesized speech comes out as unnatural for such a reason as the frequencies of speech pitch components usually discontinuously change at boundaries between the pieces of speech data.

As a method for solving the problem, it can be considered a method for preparing a plurality of pieces of speech data representing a speech that reads out the same phoneme with different prosody, while performing prosody prediction on a sentence to be subjected to the speech synthesis, selecting pieces of speech data that match the prediction result and combining them.

If more natural synthesized speech is to be obtained by a record editing method with speech data prepared for each phoneme, however, a storage device for storing the speech data needs to have a large amount of storage capacity. The amount of data to be searched also becomes large.

Therefore, as a method for quickly producing a natural synthesized speech with a simple configuration, it can be considered a method for making speech data speech piece data representing a waveforms in a unit bigger or longer than phoneme and connecting the speech piece data that matches the prosody prediction result and the speech piece data that is created in a rule synthesizing method for a part from which such speech piece data is not selected.

An audio quality of a speech represented by the speech data that is obtained in the rule synthesizing method is usually much inferior to that of the speech represented by the speech data. Therefore, in that method, a part corresponding to the speech piece data in the read out speech is quite an outstandingly high-quality sound or a part that is obtained by the rule synthesizing method is quite an outstandingly low-quality sound. That may make the read out speech sounds strange to a listener as a whole.

The present invention is adapted in view of the abovementioned circumstances and intends to provide a speech synthesis device, a speech synthesis method and a program for the same for quickly producing a natural synthesized speech with a simple configuration.

### MEANS FOR SOLVING THE PROBLEMS

In order to achieve the abovementioned objects, the speech synthesis device according to a first aspect of the present invention is characterized by including:

speech piece storing means for storing a plurality of pieces of speech piece data representing a speech piece;

selecting means for inputting sentence information representing a sentence and performing processing for selecting pieces of speech piece data with a common speech and reading that forms the sentence from each piece of the speech piece data;

missing part synthesizing means for synthesizing speech data representing a waveform of the speech for the speech whose speech piece data cannot be selected by the selecting means from the speeches that form the sentence; and

means for creating data representing the synthesized speech piece by combining the speech piece data selected by the selecting means and the speech data synthesized by the missing part synthesizing means with each other; wherein

the selecting means further includes determining means for determining whether a ratio of the speech data with a common speech and reading represented by the selected speech data in the entire speech that forms the sentence has reached a predetermined value or not; and

if it is determined that the ratio has not reached the predetermined value, the selecting means cancels selection of the speech piece data and performs processing as the speech piece data cannot be selected.

The speech synthesis device according to a second aspect of the present invention is characterized by including:

speech piece storing means for storing a plurality of pieces of speech piece data representing a speech piece;

prosody predicting means for inputting sentence information representing a sentence and predicting a prosody of the speech that forms the sentence;

selecting means for performing processing for selecting pieces of speech piece data with common speech and reading whose prosody matches a prosody prediction result under a predetermined conditions that forms the sentence from the speech piece data;

missing part synthesizing means for synthesizing speech data representing a waveform of the speech piece for the speech whose speech piece data cannot be selected by the selecting means from the speeches that form the sentence; and

means for creating data representing the synthesized speech by combining the speech piece data selected by the selecting means and the speech data synthesized by the missing part synthesizing means with each other; wherein

the selecting means further includes determining means for determining whether a ratio of the speech with common speech and reading represented by the selected speech data in the entire speech that forms the sentence has reached a predetermined value or not; and

if it is determined that the ratio has not reached the predetermined value, the selecting means cancels selection of the speech piece data and performs processing as the speech piece data cannot be selected.

The selecting means may remove the speech piece data whose prosody does not match the prosody predicting result under the predetermined conditions from objects of selection.

The missing part synthesizing means may include:

storing means for storing a plurality of pieces of data representing a phoneme or representing fragments that form the phoneme; and

synthesizing means for synthesizing the speech data representing the waveform of the speech by identifying a phoneme included in the speech whose speech piece data cannot be selected by the selecting means, obtaining pieces of data representing the identified phoneme or fragments that form the phoneme from the storing means and combining with each other.

The missing part synthesizing means may include:

missing part prosody predicting means for predicting the prosody of the speech whose speech piece data cannot be selected by the selecting means; wherein

the synthesizing means may synthesize the speech data representing the waveform of the speech by identifying the phoneme included in the speech whose speech piece data cannot be selected by the selecting means, by obtaining the data representing the identified phoneme or the fragments that form the phoneme from the storing means, converting the obtained data so that the phoneme or the speech piece represented by the data matches the prediction result of the prosody by the missing part prosody predicting means, and combining the pieces of the converted data with each other.

The missing part synthesizing means may synthesize the speech data representing the waveform of the speech piece for the speech whose speech piece data cannot be selected by the selecting means based on the prosody predicted by the prosody predicting means.

The speech piece storing means may store the prosody data representing the chronological change of the pitch of the speech piece represented by the speech piece data in association with the speech piece data;

wherein the selecting means may select the speech piece data with the common speech and reading that forms the sentences, wherein the chronological change of the pitch represented by the prosody data that is associated with the speech piece data is the nearest to the prediction result of the prosody.

The speech synthesizing device may further include speech speed converting means for obtaining speech speed data that specifies conditions of the speed in speaking the synthesized speech and selecting or converting the speech piece data and/or the speech data that form the data representing the synthesized speech so that the speech speed data represents the speech that is spoken at a speed that satisfies the specified conditions.

The speech speed converting means may convert the speech piece data and/or the speech data so that the speech speed data represents the speech that is spoken at a speed that satisfies the specified conditions by removing a section representing the fragment from the speech piece data and/or the speech data that form the data representing the synthesized speech, or adding the section representing the fragment to the speech piece data and/or the speech data.

The speech piece storing means may store the phonogram data representing the reading of the speech piece data in association with the speech piece data; wherein

the selecting means may treat the speech piece data, with which the phonogram data representing the reading that matches the reading of the speech that forms the sentences is associated, as the speech piece data whose reading is in common with the speech.

The speech synthesis method according to a third aspect of the present invention is characterized by including:

a speech piece storing step of storing a plurality of pieces of speech piece data representing a speech piece;

a selecting step of inputting sentence information representing a sentence and performing processing for selecting pieces of speech piece data with common speech and reading that forms the sentence from each piece of the speech piece data;

a missing part synthesizing step of synthesizing speech data representing a waveform of the speech for the speech whose speech piece data cannot be selected from the speech that forms the sentence; and

a step of creating data representing the synthesized speech piece by combining the selected speech piece data and the synthesized speech data with each other; wherein

the selecting step further includes a determining step of determining whether a ratio of the speech with common speech and reading represented by the selected speech data in the entire speech that forms the sentence has reached a predetermined value or not; and

if it is determined that the ratio has not reached the predetermined value, the selecting step cancels selection of the speech piece data and performs processing as the speech piece data cannot be selected.

The speech synthesis method according to a fourth aspect of the present invention is characterized by including:

a speech piece storing step of storing a plurality of pieces of speech piece data representing a speech piece;

a prosody predicting step of inputting sentence information representing a sentence and predicting a prosody of the speech that forms the sentence;

a selecting step of selecting pieces of speech piece data with common speech and reading whose prosody matches a prosody prediction result under a predetermined conditions that forms the sentence from the speech piece data;

a missing part synthesizing step of synthesizing speech data representing a waveform of the speech whose speech piece data cannot be selected from the speeches that form the sentence; and

a step of creating data representing the synthesized speech by combining the selected speech piece data and the synthesized speech data with each other; wherein

the selecting step further includes a determining step of determining whether a ratio of the speech with common speech and reading represented by the selected speech data in the entire speech that forms the sentence has reached a predetermined value or not; and

if it is determined that the ratio has not reached the predetermined value, the selecting step cancels selection of the speech piece data and performs processing as the speech piece data cannot be selected.

The program according to a fifth aspect of the present invention is a program for causing a computer to function as:

speech piece storing means for storing a plurality of pieces of speech piece data representing a speech piece;

selecting means for inputting sentence information representing a sentence and performing processing for selecting pieces of speech piece data with a common speech and reading that forms the sentence from each piece of the speech piece data;

missing part synthesizing means for synthesizing speech data representing a waveform of the speech for the speech whose speech piece data cannot be selected by the selecting means from the speeches that form the sentence; and

means for creating data representing the synthesized speech piece by combining the speech piece data selected by the selecting means and the speech data synthesized by the missing part synthesizing means; characterized in that

the selecting means further includes determining means for determining whether a ratio of the speech with a common speech and reading represented by the selected speech data in the entire speech that forms the sentence has reached a predetermined value or not; and

if it is determined that the ratio has not reached the predetermined value, the selecting means cancels selection of the speech piece data and performs processing as the speech piece data cannot be selected.

The program according to a sixth aspect of the present invention is a program for causing a computer to function as:

speech piece storing means for storing a plurality of pieces of speech piece data representing a speech piece;

prosody predicting means for inputting sentence information representing a sentence and predicting a prosody of the speech that forms the sentence;

selecting means for performing processing for selecting pieces of speech piece data with common speech and reading whose prosody matches a prosody prediction result under a predetermined conditions that forms the sentence from the speech piece data;

missing part synthesizing means for synthesizing speech data representing a waveform of the speech piece for the speech whose speech piece data cannot be selected by the selecting means from the speeches that form the sentence; and

means for creating data representing the synthesized speech by combining the speech piece data selected by the selecting means and the speech data synthesized by the missing part synthesizing means with each other; characterized in that

the selecting means further includes determining means for determining whether a ratio of the speech with common speech and reading represented by the selected speech data in the entire speech that forms the sentence has reached a predetermined value or not; and

if it is determined that the ratio has not reached the predetermined value, the selecting means cancels selection of the speech piece data and performs processing as the speech piece data cannot be selected.

### ADVANTAGE OF THE INVENTION

As mentioned above, according to the present invention, a speech synthesis device, a speech synthesis method and a program for the same are realized for quickly producing natural synthesized speech with a simple configuration.

### BRIEF DESCRIPTION OF THE DRAWINGS

FIG. 1 is a block diagram showing an arrangement of the speech synthesis system according to a first embodiment of the present invention;

FIG. 2 is a diagram schematically showing a data structure of a speech piece database;

FIG. 3 is a block diagram showing an arrangement of the speech synthesis system according to a second embodiment of the present invention;

FIG. 4 is a flowchart showing processing in the case in which a personal computer that performs functions of the speech synthesis system according to the first embodiment of the present invention obtains a free text data;

FIG. 5 is a flowchart showing processing in the case in which the personal computer that performs functions of the speech synthesis system according to the first embodiment of the present invention obtains distributed character string data;

FIG. 6 is a flowchart showing processing in the case in which the personal computer that performs functions of the speech synthesis system according to the first embodiment of the present invention obtains a standard-size message data and an utterance speed data;

FIG. 7 is a flowchart showing processing in the case in which a personal computer that performs functions of a unit body in FIG. 3 obtains the free text data;

FIG. 8 is a flowchart showing processing in the case in which the personal computer that performs the functions of the unit body in FIG. 3 obtains the distributed character string data; and

FIG. 9 is a flowchart showing processing in the case in which the personal computer that performs the functions of the unit body in FIG. 3 obtains standard-size message data and utterance speed data.

### BEST MODES FOR CARRYING OUT THE INVENTION

Embodiments of the present invention will be described with reference to the drawings.

### First Embodiment

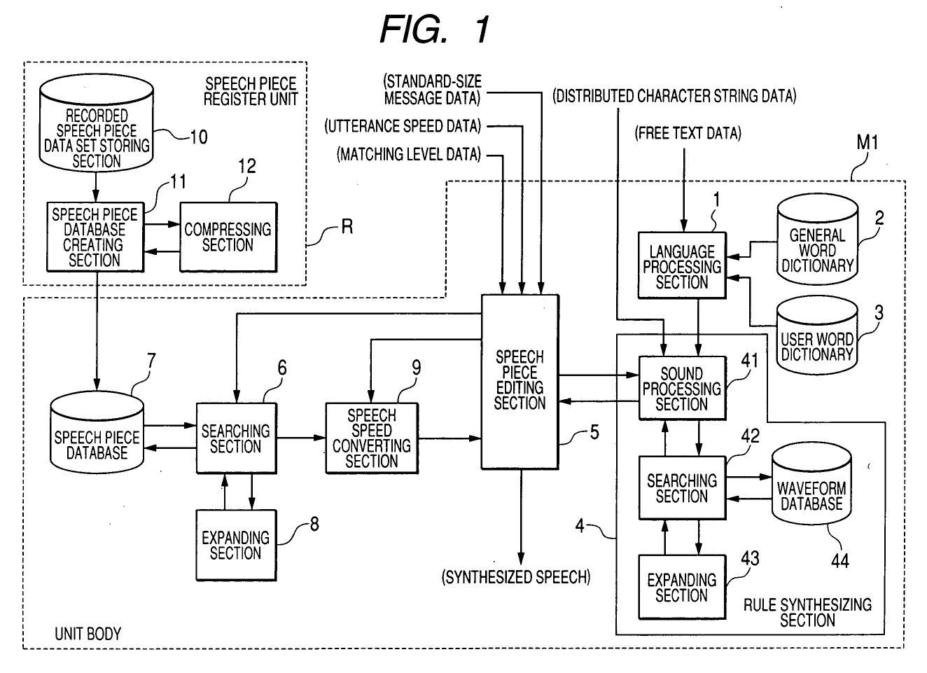

FIG. 1 is a diagram showing an arrangement of the speech synthesis system according to the first embodiment of the present invention.

As shown in the figure, the speech synthesis system includes a unit body M1 and a speech piece register unit R.

The unit body M1 includes a language processing section 1, a general word dictionary 2, a user word dictionary 3, a rule synthesizing section 4, a speech piece editing section 5, a searching section 6, a speech piece database 7, an expanding section 8 and a speech speed converting section 9. Among them, the rule synthesizing section 4 includes a sound processing section 41, a searching section 42, an expanding section 43 and a waveform database 44.

Each of the language processing section 1, the sound processing section 41, the searching section 42, the expanding section 43, the speech piece editing section 5, the searching section 6, the expanding section 8 and the speech speed converting section 9 includes a processor such as a CPU (Central Processing Unit), a DSP (Digital Signal Processor) and the like and a memory for storing a program to be executed by the processor, each of which performs processing to be described later.

A single processor may perform a part or all the functions of the language processing section 1, the sound processing section 41, the searching section 42, the expanding section 43, the speech piece editing section 5, the searching section 6, the expanding section 8 and the speech speed converting section 9. Therefore, the processor that performs the functions of the expanding section 43 may also perform the function of the expanding section 8, for example. A single processor may cover the functions of the sound processing section 41, the searching section 42 and the expanding section 43.

The general word dictionary 2 includes a non-volatile memory such as a PROM (Programmable Read Only Memory), a hard disk device and the like. The general word dictionary 2 in which a word and the like including an ideogram (for example, a Chinese character) and a phonogram (for example, KANA or phonetic symbols) representing the reading of the word and the like are stored by a manufacturer or the like of the speech synthesis system in advance with associated with each other.

The user word dictionary 3 includes a data rewritable non-volatile memory such as the EEPROM (Electrically Erasable/Programmable Read Only Memory), a hard disk device and the like and a control circuit for controlling writing of data into the non-volatile memory. The processor may perform the function of the control circuit. Alternatively, the processor that performs a part or all the functions of the language processing section 1, the sound processing section 41, the searching section 42, the expanding section 43, the speech piece editing section 5, the searching section 6, the expanding section 8 and the speech speed converting section 9 may perform the function of the control circuit of the user word dictionary 3.

The user word dictionary 3 obtains words from outside and the like including an ideogram and a phonogram representing the reading of the words and the like according to a user's operation and stores them in association with each other. The user word dictionary 3 only needs to store the words and the like that are not stored in the general word dictionary 2 and the phonograms representing the reading of the words and the like.

The waveform database 44 includes a non-volatile memory such as a PROM, a hard disk device and the like. The waveform database 44 stores phonogram and compressed waveform data that is obtained as the waveform data representing a waveform of a unit speech represented by the phonogram is subjected to entropy coding in advance in association with each other by a manufacturer of the speech synthesis system. The unit speech is the speech short enough to be used in the method of the rule synthesizing method, and specifically the speech separated by such a unit of phoneme or a VCV (Vowel-Consonant-Vowel) syllable. The waveform data before being subjected to the entropy coding only needs to include digital format data that is subjected to the PCM (Pulse Code Modulation), for example.

The speech piece database 7 includes a non-volatile memory such as a PROM, a hard disk device and the like.

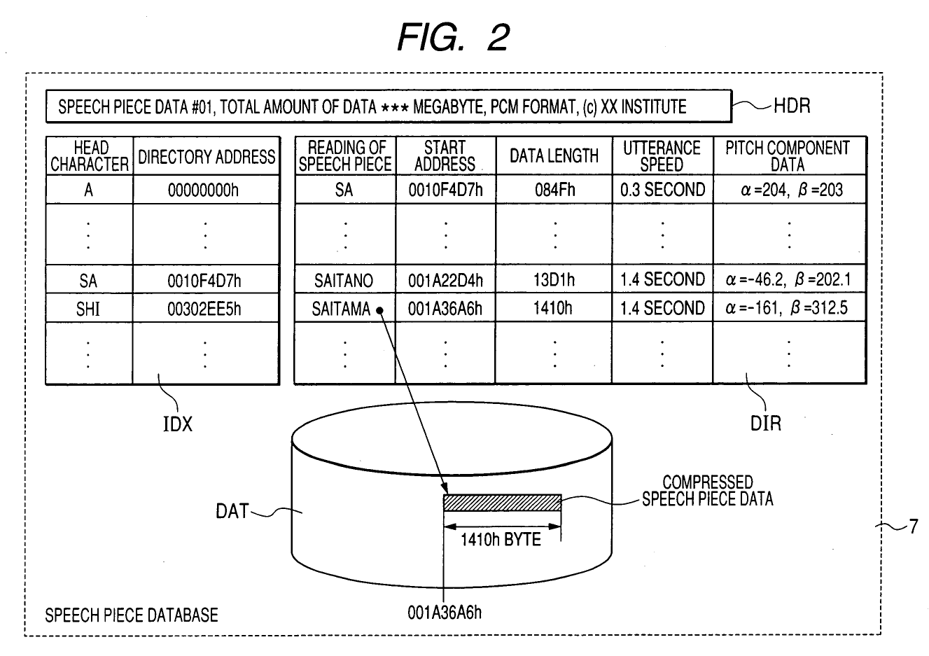

The speech piece database 7 stores data in a data structure shown in FIG. 2, for example. That is, as shown in the figure, the data stored in the speech piece database 7 is divided into four parts of a header part HDR, an index part IDX, a directory part DIR and a data part DAT.

The data is previously stored in the speech piece database 7 by, for example, the manufacturer of the speech synthesis system and/or stored as the speech piece register unit R performs operation to be described later.

The header part HDR stores data for identifying the speech piece database 7, the amount of data of the index part IDX, the directory part DIR and the data part DAT, a data format, and data indicating an attribute such as a copyright and the like.

The data part DAT stores compressed speech piece data that is obtained as the speech piece data representing a waveform of the speech piece is subjected to entropy coding.

The speech piece refers to one of serial sections, each of which includes one or more phonemes of speech. Usually, the speech piece consists of sections for one or more words. The speech piece may include a conjunction.

The speech piece data before being subjected to the entropy coding only needs to include the data in the same format as that of the waveform data before being subjected to the entropy coding for producing the abovementioned compressed waveform data (for example, data in digital format that is subjected to the PCM).

For each piece of the compressed speech data, the directory part DIR stores

(A) data representing a phonogram representing the reading of the speech piece represented by the compressed speech piece data (speech piece reading data),

(B) data representing the top address of the storage location where the compressed speech piece data is stored,

(C) data representing the data length of the compressed speech piece data,

(D) data representing an utterance speed (a time length when the data is played) of the speech piece represented by the compressed speech piece data (speed default value data), and

(E) data representing a chronological change in frequencies of speech piece pitch components (pitch component data) in association with each other. (Assuming that an address is added to the storage region of the speech piece database 7).

FIG. 2 exemplifies a case in which compressed speech piece data with 1410 h byte amount of data that represents the waveform of the speech piece reading “SAITAMA” is stored at the logical location whose top address is 001A36A6h as data included in the data part DAT. (In the specification and the diagrams, the number with “h” added at the end represents a hexadecimal digit).

At least data (A) in the collection of pieces of data from abovementioned (A) to (E) (i.e., the speech piece reading data) is stored in the storage region of the speech piece database 7 as it is sorted according to the order decided based on the phonogram represented by the speech piece reading data (for example, if the phonogram is KANA, the pieces of data are sorted in the descending order of the address according to the order of the Japanese syllabary).

The abovementioned pitch components data only needs to consist of data indicating values of a fraction of a linear function on an elapsed time from the top of the speech piece β and an inclination α in the case where the frequency of the pitch components of the speech piece is approximated by the linear function. (The unit of the inclination α only needs to be [hertz/seconds], for example, and the unit of the fraction β only needs to be [hertz], for example.

It is assumed that the pitch components data also includes data (not shown) indicating whether the speech piece represented by the compressed speech piece data is read out as a nasal consonant or not, and whether it is read out as a voiceless consonant or not.

The index part IDX stores data for identifying the approximate logical location of the data in the directly part DIR based on the speech piece reading data. Specifically, it stores a KANA character and data (directly address) indicating the range of the address at which the speech piece reading data whose top character is the KANA character is present (directory address) in association with each other, assuming that the speech piece reading data represents the KANA.

A single non-volatile memory may perform a part or all the functions of the general word dictionary 2, the user word dictionary 3, the waveform database 44 and the speech piece database 7.

The speech piece register unit R includes a recorded speech piece data set storing section 10′, a speech piece database creating section 11 and a compressing section 12 as shown in the figure. The speech piece register unit. R may be detachably connected with the speech piece database 7. In such a case, the unit body M1 may be caused to operate the operations to be described later as the speech piece register unit R is in a disconnected state from the unit body M1 except for the case in which new data is written into the speech piece database 7.

The recorded speech piece data set storing section 10 includes a data rewritable non-volatile memory such as the hard disk device and the like.

The recorded speech piece data set storing section 10 stores an phonogram representing the reading of the speech piece, and speech piece data representing the waveform that is obtained as the speech piece actually uttered by persons are collected in association with each other in advance by the manufacturer or the like of the speech synthesis system. The speech piece data only needs to consist of digital format data that is subjected to the PCM, for example.

The speech piece database creating section 11 and the compressing section 12 include a processor such as a CPU and the like and a memory for storing the program to be executed by the processor and perform processing to be described later according to the program.

A single processor may perform a part or all the functions of the speech piece database creating section 11 and the compressing section 12. A processor that performs a part or all the functions of the language processing section 1, the sound processing section 41, the searching section 42, the expanding section 43, the speech piece editing section 5, the searching section 6, the expanding section 8 and the speech speed converting section 9 may further perform the function of the speech piece database creating section 11 and the compressing section 12. The processor that performs the functions of the speech piece database creating section 11 and the compressing section 12 may also function as the control circuit of the recorded speech piece data set storing section 10.

The speech piece database creating section 11 reads out a phonogram and speech piece data that are associated with each other from the recorded speech piece data set storing section 10, and identifies the chronological change in frequencies of speech pitch components and the utterance speed which are represented by the speech piece data.

The utterance speed only needs to be identified by, for example, counting the number of samples of the speech piece data.

On the other hand, the chronological change in frequencies of pitch components only needs to be identified by performing the cepstrum analysis on the speech piece data, for example. Specifically, the waveform represented by the speech piece data is separated into many small fractions on the time axis, the strength of each of the obtained small fractions is converted into a value virtually the same as the logarithm of the original value (the base of the logarithm is arbitrarily decided), and the spectrum of each of the small fraction into which the value is changed (i.e., cepstrum) is obtained by the method of the fast Fourier transformation (or, another method for creating data representing the result which is a discrete variable is subjected to the Fourier transformation). Then, the minimum value among the frequencies, which give the maximal value of the cepstrum, is identified as the frequency of the pitch components in the small fraction.

It can be expected to have the preferable result of identifying the chronological change in frequencies of pitch components if the chronological change is identified by converting the speech piece data into the pitch waveform data along the method disclosed in Japanese Patent Application Laid-Open No. 2003-108172 and then identifying the chronological change based on the pitch waveform data. Specifically, the speech piece data only needs to be converted into the pitch waveform signal by filtering the speech piece data and extracting the pitch signal, separating the waveform represented by the speech piece data into sections of unit pitch length based on the extracted pitch signal, identifying shifts between the phases based on correlation of each section and the pitch signal and aligning the phases of respective sections. Then, it only needs to identify the chronological change in frequencies of pitch components by performing the cepstrum analysis by using the obtained pitch waveform signal as the speech piece data.

On the other hand, the speech piece database creating section 11 supplies the speech piece data read from the recorded speech piece data set storing section 10 to the compressing section 12.

The compressing section 12 creates the compressed speech piece data by performing the entropy coding on the speech piece data supplied by the speech piece database creating section 11 and returns the compressed speech piece data to the speech piece database creating section 11.

When the chronological change in the utterance speed and frequencies of pitch components of the speech piece data are identified and the speech piece data is subjected to the entropy coding and returned as the compressed speech piece data by the compressing section 12, the speech piece database creating section 11 writes the compressed speech piece data into the storage of the speech piece database 7 as data included in the data part DAT.

The speech piece database creating section 11 writes the phonogram read from the recorded speech piece data set storing section 10 into the storage of the speech piece database 7 as the speech piece reading data, taking the phonogram as what indicating the reading of the speech piece represented by the written compressed speech piece data.

The speech piece database creating section 11 also identifies the top address in the storage of the speech piece database 7 and writes the address into the storage of the speech piece database 7 as the abovementioned data of (B).

It also identifies the data length of the compressed speech piece data and writes the identified data length into the storage of the speech piece database 7 as the data of (C).

It creates data indicating the result of identification of the chronological change in the utterance speed of the speech piece and the frequencies of the pitch components represented by the compressed speech piece data, and writes the data into the storage of the speech piece database 7 as the speed default value data and the pitch component data.

Now, operations of the speech synthesis system will be described.

In the description, it is assumed that the language processing section 1 first obtains, from outside free text data in which sentences (free text) including an ideogram prepared by a user to make the speech synthesis system to synthesize speech for it.

Here, the language processing section 1 may obtain the free text data in any method. It may obtain the free text data from an external device or a network via an interface circuit (not shown), for example, or may read the free text data from a recording medium that is set in a recording medium drive device (not shown) (for example, a floppy (registered trademark) disk or a CD-ROM) via the recording medium drive device.

The processor that performs the function of the language processing section 1 may pass text data that was used in other processing executed by the processor to the processing of the language processing section 1 as the free text data.

The abovementioned other processing executed by the processor may include the processing for causing the processor to perform the function of an agent device that is performed by obtaining the speech data representing speech, identifying the speech piece represented by the speech by performing speech recognition on the speech data, identifying the contents of a request by a speaker of the speech based on the identified speech piece, and identifying the processing that should be performed to fulfill the identified request.

When the language processing section 1 obtains the free text data, it identifies a phonogram representing the reading of each ideogram included in the free text by searching the general word dictionary 2 and the user word dictionary 3. Then, it replaces the ideogram with the identified phonogram. Then, the language processing section 1 supplies a phonogram string obtained by replacing all the ideograms in the free text by the phonogram to the sound processing section 41.

When the sound processing section 41 is supplied with the phonogram string from the language processing section 1, it instructs the searching section 42 to search for the waveform of the unit speech represented by the phonogram for each phonogram included in the phonogram string.

In response to the instruction, the searching section 42 searches the waveform database 44 for the compressed waveform data representing the waveform of the unit speech represented by each phonogram included in the phonogram string. Then, it supplies the searched out compressed waveform data to the expanding section 43.

The expanding section 43 restores the waveform data before compression from the compressed waveform data supplied from the searching section 42 and returns the restored waveform data to the searching section 42. The searching section 42 supplies the waveform data returned from the expanding section 43 to the sound processing section 41 as a search result.

The sound processing section 41 supplies the waveform data supplied from the searching section 42 to the speech piece editing section 5 in the order of the phonograms arranged in the phonogram string supplied by the language processing section 1.

When the speech piece editing section 5 is supplied with the waveform data from the sound processing section 41, it combines pieces of the waveform data with each other in the supplied order and outputs it as data representing the synthesized speech (synthesized speech data). The synthesized speech that is synthesized based on the free text data corresponds to the speech synthesized in the method of the rule synthesizing method.

The speech piece editing section 5 may output the synthesized speech data in any method. It may play the synthesized speech represented by the synthesized speech data via a D/A (Digital-to-Analog) converter or a speaker (not shown), for example. It may also sends out the synthesized speech data to an external device or a network via an interface circuit (not shown) or write the synthesized speech data into the recording medium that is set in the recording medium drive device (not shown) via the recording medium drive device. The processor that performs the function of the speech piece editing section 5 may pass the synthesized speech data to other processing that the processor is performing.

It is assumed that the sound processing section 41 obtains the data (distributed character string data) representing the phonogram string distributed from outside. (The sound processing section 41 may also obtain the distributed character string data in any method. For example, it may obtain the distributed character string data in the same method as that for the language processing section 1 to obtain the free text data.)

In such a case, the sound processing section 41 treats the phonogram string represented by the distributed character string data as the phonogram string supplied by the language processing section 1. As a result, the compressed waveform data corresponding to the phonogram included in the phonogram string represented by the distributed character string data is searched by the searching section 42 and the waveform data before the compression is restored by the expanding section 43. Each piece of the restored waveform data is supplied to the speech piece editing section 5 via the sound processing section 41. The speech piece editing section 5 combines the pieces of waveform data with each other in the order of the phonograms arranged in the phonogram string represented by the distributed character string data and outputs it as the synthesized speech data. The synthesized speech data that is synthesized based on the distributed character string data also represents the speech synthesized in the method of the rule synthesizing method.

It is assumed that the speech piece editing section 5 next obtains a standard-size message data, an utterance speed data and a matching level data.

The standard-size message data is data representing the standard-size message as the phonogram string, the utterance speed data is data for indicating a specified value of the utterance speed of the standard-size message represented by the standard-size message data (the specified value of the time length for uttering the standard-size message). The matching level data is data for specifying a searching condition in the searching processing to be described later performed by the searching section 6. It is assumed that the matching level data takes any value of “1”, “2” and “3” below, with “3” being the most strict searching condition.

The speech piece editing section 5 may obtain the standard-size message data, the utterance speed data or the matching level data in any method. For example, it may obtain the standard-size message data, the utterance speed data or the matching level data in the same method as the language processing section 1 obtains the free text data.

When the standard-size message data, the utterance speed data and the matching level data are supplied to the speech piece editing section 5, the speech piece editing section 5 instructs the searching section 6 to search for all the compressed speech piece data that is associated with the phonogram, which matches the phonogram representing the reading of the speech piece included in the standard-size message.

In response to the instruction by the speech piece editing section 5, the searching section 6 searches the speech piece database 7 for the corresponding compressed speech piece data, the abovementioned speech piece reading data corresponding to the corresponding compressed speech piece data, the speed default value data and the pitch component data, and supplies the searched compressed waveform data to the expanding section 43. If a plurality of pieces of the compressed speech piece data correspond to the common phonogram string and ideogram string, all the pieces of corresponding compressed speech piece data are searched as candidates for data to be used in the speech synthesis. On the other hand, if the searching section 6 has a speech piece for which no compressed speech piece data is searched out, it produces data for identifying the corresponding speech piece (hereinafter, referred to as missing part identifying data).

The expanding section 43 restores the speech piece data before the compression from the compressed speech piece data supplied from the searching section 6 and returns it to the searching section 6. The searching section 6 supplies the speech piece data returned by the expanding section 43, the searched out speech piece reading data, speed default value data and pitch component data to the speech speed converting section 9 as searched results. If the missing part identifying data is produced, the missing part identifying data is also supplied to the speech speed converting section 9.

On the other hand, the speech piece editing section 5 instructs the speech speed converting section 9 to convert the speech piece data supplied to the speech speed converting section 9 and make the time length of the speech piece represented by the speech piece data match the speed indicated by the utterance speed data.

In response to the instruction from the speech piece editing section 5, the speech speed converting section 9 converts the speech piece data supplied from the searching section 6 to match the instruction and supplies the data to the speech piece editing section 5. Specifically, for example, the speech speed converting section 9 only needs to identify the original time length of the speech piece data supplied by the searching section 6 based on the searched out speed default value data, then to resample the speech piece data and make the number of samples of the speech piece data the time length that matches the speed instructed by the speech piece editing section 5.

The speech speed converting section 9 also supplies the speech piece reading data and the pitch component data supplied from the searching section 6 to the speech piece editing section 5. If the speech speed converting section 9 is supplied with the missing part identifying data from the searching section 6, it further supplies the missing part identifying data to the speech piece editing section 5.

If the utterance speed data is not supplied to the speech piece editing section 5, the speech piece editing section 5 only needs to instruct the speech speed converting section 9 to supply the speech piece data supplied to the speech speed converting section 9 to the speech piece editing section 5 without converting. In response to the instruction, the speech speed converting section 9 only needs to supply the speech piece data supplied from the searching section 6 to the speech piece editing section 5 as it is.

When the speech piece editing section 5 is supplied with the speech piece data, the speech piece reading data and the pitch component data by the speech speed converting section 9, it selects a piece of speech piece data representing the waveform that can be approximated to the waveform of the speech piece that forms the standard-size message for one speech piece among the supplied pieces of speech piece data. Here, the speech piece editing section 5 sets whether or not to make the waveform that fulfills any conditions the waveform near the speech piece of the standard-size message according to the obtained matching level data.

Specifically, the speech piece editing section 5 first predicts the prosody of the standard-size message (accent, intonation, stress, time length of phoneme and the like) by performing analysis based on the method of prosody prediction such as, for example “Fujisaki model”, “ToBI (Tone and Break Indices)” and the like on the standard-size message represented by the standard-size message data.

Next, the speech piece editing section 5

(1) selects all the speech piece data supplied by the speech speed converting section 9 (i.e., the speech piece data whose reading matches that of the speech piece in the standard-size message) as the speech piece data near the waveform of the speech piece in the standard-size message, if the value of the matching level data is “1”.

(2) If the value of the matching level data is “2”, the speech piece editing section 5 selects the speech piece data as the speech piece data near the waveform of the speech piece in the standard-size message as far as the conditions of (1) (i.e., the conditions of matching the phonogram representing the reading) are fulfilled and there is strong correlation between the contents of the pitch component data representing the chronological change in frequencies of pitch components of the speech piece data and the prediction result of the accent of the speech piece included in the standard-size message (so-called prosody) by a predetermined amount or more (for example, if a time difference of locations of the accents is a predetermined amount or less). The prediction result of the accent of the speech piece in the standard-size message can be identified by the prediction result of the prosody of the standard-size message. The speech piece editing section 5 only needs to interpret the location where the frequency of the pitch components is predicted to be the highest as the predicted location for the accent, for example. On the other hand, as for the location of the accent of the speech piece represented by the speech piece data, it only needs to identify the location where the frequency of the pitch component is the highest based on the abovementioned pitch component data and interpret the location as the accent location. The prosody may be predicted for the entire sentences. Alternatively, the prosody may be predicted by dividing the sentences by a predetermined unit and predicting for each unit.

(3) If the value of the matching level data is “3”, the speech piece editing section 5 selects the speech piece data as the speech piece data near the waveform of the speech piece in the standard-size message as far as the conditions of (2) (i.e., the conditions of matching the phonogram and the accent representing the reading) are fulfilled and whether the speech represented by the speech piece data is read out as a nasal consonant or a voiceless consonant matches the prediction result of the prosody of the standard-size message. The speech piece editing section 5 only needs to determine whether the speech represented by the speech piece data is read out as a nasal consonant or a voiceless consonant based on the pitch component data supplied by the speech speed converting section 9.

If the speech piece editing section 5 has a plurality of pieces of speech piece data that match the conditions set by itself for a speech piece, it narrows the plurality of pieces of speech piece data into a piece according to the condition stricter than the set conditions.

Specifically, the speech piece editing section 5 performs operations as below: If the set conditions correspond to the value of the matching level data “1” and there are a plurality of pieces of the corresponding speech piece data, for example, it selects the pieces which also match the searching conditions corresponding to the value of the matching level data “2”. If a plurality of pieces of speech piece data are selected, it further selects the pieces which match the searching conditions corresponding to the value of the matching level data “3” among the selected result. If it narrows the plurality of pieces by the searching conditions corresponding to the value of the matching level data “3” and still has a plurality of pieces of speech piece data, it only needs to narrow that remaining pieces according to arbitrary standard.

Then, the speech piece editing section 5 determines whether a ratio of the number of characters of the phonograms string representing the reading of the speech piece for which the speech piece data representing the waveform that can be approximated is selected to the total number of characters of the phonogram string forming the standard-size message data (or, a ratio of the part other than the part representing the reading of the speech piece indicated by the missing part identifying data supplied from the speech speed converting section 9 to the total number of characters in the phonogram string that forms the standard-size message data) has reached a predetermined threshold or not.

If it is determined that the abovementioned ratio has reached the threshold and if the missing part identifying data is also supplied from the speech speed converting section 9, the speech piece editing section 5 extracts the phonogram string representing the reading of the speech piece indicated by the missing part identifying data from the standard-size message data and supplies it to the sound processing section 41, and instructs the sound processing section 41 to synthesize the waveform of the speech piece.

The instructed sound processing section 41 treats the phonogram string supplied from the speech piece editing section 5 as the phonogram string represented by the distributed character string data. As a result, the compressed waveform data representing the waveform of the speech indicated by the phonogram included in the phonogram string is searched out by the searching section 42, and the original waveform is restored by the expanding section 43 from the compressed waveform data and supplied to the sound processing section 41 via the searching section 42. The sound processing section 41 supplies the waveform data to the speech piece editing section 5.

When the waveform data is returned from the sound processing section 41 to the speech piece editing section 5, it combines the waveform data and that selected by the sound editing section 5 from the speech piece data supplied from the speech speed converting section 9 with each other in the order of the phonograms arranged in the phonogram string in the standard-size message indicated by the standard-size message data and outputs it as data representing the synthesized speech.

If the data supplied by the speech speed converting section 9 includes no missing part identifying data, the speech piece editing section 5 only needs to immediately combine the pieces of the speech piece data selected by the speech piece editing section 5 with each other in the order of the phonograms arranged in the phonogram string in the standard-size message indicated by the standard-size message data and outputs it as data representing the synthesized speech without instructing the sound processing section 41 to synthesize the waveform.

On the other hand, if it is determined that the abovementioned ratio has not reached the threshold, the speech piece editing section 5 decides not to use the speech piece data in the speech synthesis (in other words, to cancel to select the speech piece data), supplies the entire phonogram string that forms the standard-size message data to the sound processing section 41 and instructs the sound processing section 41 to synthesize the waveform of the speech piece.

The instructed sound processing section 41 treats the phonogram string supplied by the sound editing section 5 as the phonogram string represented by the distributed character string data. As a result, the sound processing section 41 supplies the waveform data representing the waveform of the speech indicated by the phonogram included in the phonogram string to the speech piece editing section 5.

When the waveform data is returned from the sound processing section 41 to the speech piece editing section 5, it combines the pieces of the waveform data in the order of the speech pieces arranged in the standard-size message indicated by the standard-size message data and outputs it as the data representing the synthesized speech.

In the speech synthesis system mentioned above according to the first embodiment of the present invention, pieces of the speech piece data representing the waveform of the speech piece that can be a unit larger than a phoneme are naturally combined in the record editing method based on the prediction result of the prosody so that the speech reading out the standard-size message is synthesized. The storage capacity of the speech piece database 7 can be smaller than that for storing the waveform for each phoneme and can be searched quickly. As such, the speech synthesis system can be light and compact and can also catch up with quick processing.

If a proportion of the speech piece that can be approximated by the speech piece represented by the speech piece data in the entire speech pieces that forms the standard-size message has not reached the abovementioned threshold, the speech synthesis system performs the speech synthesis by the method of the rule synthesizing method on the entire standard-size message without using the speech piece data representing the speech piece that can be approximated for the speech synthesis. As such, if the standard-size message includes small number of speech pieces that can be approximated by the speech piece represented by the speech piece data, unevenness in quality of the speech pieces in the synthesized speech is not so outstanding, so that it has little unnatural sound.

The configuration of the speech synthesis system is not limited to that mentioned above.

The waveform data or the speech piece data needs not to be the data in the PCM format, for example, and the data may have any data format.

The waveform database 44 or the speech piece database 7 needs not to store the waveform data or the speech piece data in the state of being subjected to the data compression. If the waveform database 44 or the speech piece database 7 stores the waveform data or the speech piece data in the state of not being subjected to the data compression, the unit body M1 needs not to have the expanding section 43.

The waveform database 44 needs not to store the unit speech in a form separated individually. It may store the waveform of the speech formed by a plurality of unit speeches and data for identifying the location where each unit speech occupies in the waveform. In such a case, the speech piece database 7 may perform the function of the waveform database 44. That is, a series of pieces of speech data may be stored in the waveform database 44 in the same form as those in the speech piece database 7. In such a case, a phonogram, pitch information and the like are stored for each phoneme in the speech data in association with each other so as to be used as the waveform database.

The speech piece database creating section 11 may read the speech piece data or the phonogram string that make materials for new compressed speech piece data to be added to the speech piece database 7 from the recording medium set in the recording medium drive device (not shown) via the recording medium drive device.

The speech piece register unit R needs not to have the recorded speech piece data set storing section 10.

The pitch component data may also be the data representing chronological change of the pitch length of the speech piece represented by the speech piece data. In such a case, the speech piece editing section 5 only needs to identify the location where the pitch length is the shortest (i.e., the location where the frequency is the highest) based on the pitch component data and interpret the location as the accent location.

The speech piece editing section 5 previously stores prosody register data that represents the prosody of a particular speech piece, and if the standard-size message includes the particular speech piece, it may treat the prosody represented by the prosody register data as the result of prosody prediction.

The speech piece editing section 5 may also store the result of the past prosody prediction anew as the prosody register data.

The speech piece database creating section 11 may include a microphone, an amplifier, a sampling circuit, an A/D (Analog-to-Digital) converter and a PCM encoder. In such a case, the speech piece database creating section 11 may create the speech piece data by amplifying the speech signals representing the speech collected by its own microphone, sampling and performing the A/D conversion on the signals, and then performing the PCM modulation on the sampled speech signals, instead of obtaining the speech piece data from the recorded speech piece data set storage section 10.

The speech piece editing section 5 may match the time length of the waveform represented by the waveform data with the speed indicated by the utterance speed data by supplying the waveform data returned from the sound processing section 41 to the speech speed converting section 9.

The speech piece editing section 5 may obtain the free text data with the language processing section 1, for example, and select the speech piece data that matches at least a part of the speech (phonogram string) included in the free text represented by the free text data by performing virtually the same processing as the selecting processing of the speech piece data of the standard-size message so as to use it in the speech synthesis.

In such a case, the sound processing section 41 needs not to cause the searching section 42 to search for the waveform data representing the waveform of the speech piece for the speech piece selected by the speech piece editing section 5. The speech piece editing section 5 only needs to report the speech piece that needs not to be synthesized by the sound processing section 41 to the sound processing section 41 so that the sound processing section 41 stops searching for the waveform of the unit speech that forms the speech piece in response to the report.

The speech piece editing section 5 may, for example, obtain the distributed character string data with the sound processing section 41, select the speech piece data representing the phonogram string included in the distributed character string that is represented by the distributed character string data by performing virtually the same processing as the selecting processing of the speech piece data of the standard-size message so as to use it in the speech synthesis. In such a case, the sound processing section 41 needs not to cause the searching section 42 to search for the waveform data representing the waveform of the speech piece for the speech piece represented by the speech piece data selected by the speech piece editing section 5.

### Second Embodiment

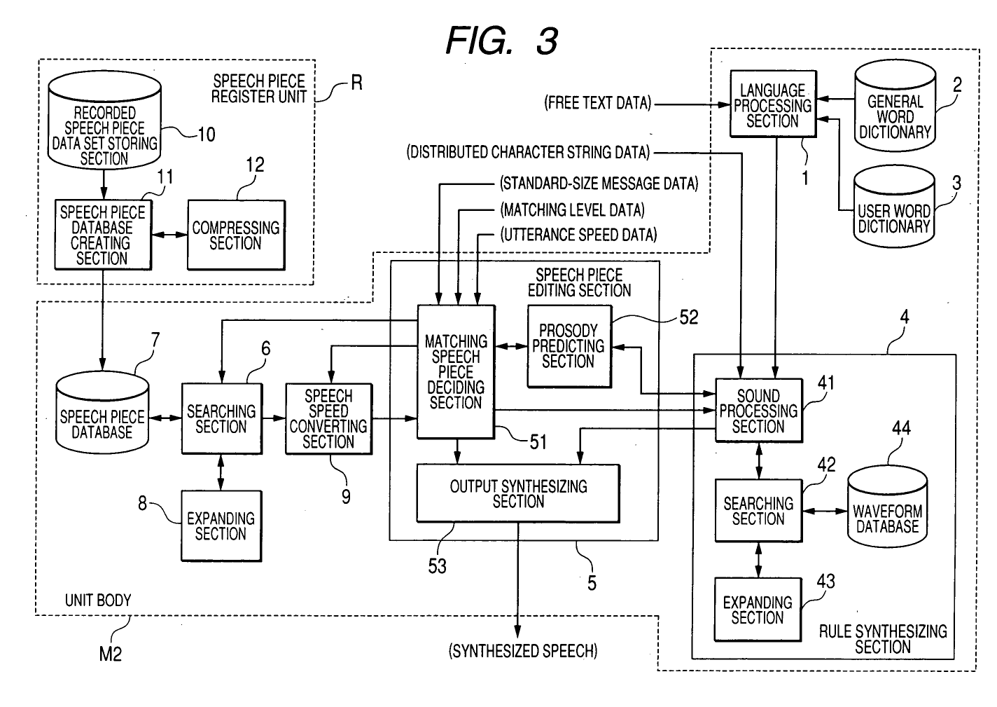

Now, the second embodiment of the present invention will be described. FIG. 3 is a diagram showing an arrangement of the speech synthesis system according to the second embodiment of the present invention. As shown in the figure, the speech synthesis system also includes the unit body M2 and the speech piece register unit R as the first embodiment. Among them, the speech piece register unit R has virtually the same configuration as that in the first embodiment.

The unit body M2 includes a language processing section 1, a general word dictionary 2, a user word dictionary 3, a rule synthesizing section 4, a speech piece editing section 5, a searching section 6, a speech piece database 7, an expanding section 8 and a speech speed converting section 9. Among them, the language processing section 1, the general word dictionary 2, the user word dictionary 3 and the speech piece database 7 have virtually the same configuration of those in the first embodiment.

Each of the language processing section 1, the speech piece editing section 5, the searching section 6, the expanding section 8 and the speech speed converting section 9 includes a processor such as a CPU and a DSP and the like and a memory for storing a program to be executed by the processor, each of which performs processing to be described later. A single processor may perform a part or all the functions of the language processing section 1, the searching section 42, the expanding section 43, the speech piece editing section 5, the searching section 6 and the speech speed converting section 9.

The rule synthesizing section 4 includes the sound processing section 41, the searching section 42, the expanding section 43 and the waveform database 44 as that in the first embodiment. Among them, each of the sound processing section 41, the searching section 42, and the expanding section 43 includes a processor such as a CPU and a DSP and the like and a memory for storing a program to be executed by the processor, each of which performs processing to be described later.

A single processor may perform a part or all the functions of the sound processing section 41, the searching section 42 and the expanding section 43. The processor that performs a part or all the functions of the language processing section 1, the searching section 42, the expanding section 43, the speech piece editing section 5, the searching section 6, the expanding section 8 and the speech speed converting section 9 may further perform a part or all the functions of the sound processing section 41, the searching section 42 and the expanding section 43. Therefore, the expanding section 8 may also perform the function of the expanding section 43 of the rule synthesizing section 4, for example.

The waveform database 44 includes a non-volatile memory such as a PROM, a hard disk device and the like. The waveform database 44 stores phonograms and compressed waveform data that is obtained as fragment waveform data that represents fragments that form phonemes represented by the phonograms (i.e., speech for a cycle (or, for a certain number) of the waveform of the speech that forms a phoneme) subjected to entropy coding in advance in association with each other by a manufacturer of the speech synthesis system. The fragment waveform data before the entropy coding may include digital format data that is subjected to the PCM, for example.

The speech piece editing section 5 includes a matching speech piece deciding section 51, a prosody predicting section 52 and an output synthesizing section 53. Each of the matching speech piece deciding section 51, the prosody predicting section 52 and the output synthesizing section 53 includes a processor such as a CPU, a DSP (Digital Signal Processor) and the like and a memory for storing a program to be executed by the processor, each of which performs processing to be described later.

A single processor may perform a part or all the functions of the matching speech piece deciding section 51, the prosody predicting section 52 and the output synthesizing section 51. A processor that performs a part or all the functions of the language processing section 1, the sound processing section 41, the searching section 42, the expanding section 43, the speech piece editing section 5, the searching section 6, the expanding section 8 and the speech speed converting section 9 may further perform a part or all functions of the matching speech piece deciding section 51, the prosody predicting section 52 and the output synthesizing section 53. Therefore, the processor for performing the function of the output synthesizing section 53 may further perform the functions of the speech speed converting section 9, for example.

Now, the operations of the speech synthesis system in FIG. 3 will be described.

First, it is assumed that the language processing section 1 obtains virtually the same free text data as that in the first embodiment from outside. In such a case, the language processing section 1 replaces the ideogram included in the free text with the phonogram by performing virtually the same processing as that in the first embodiment. Then, it supplies the phonogram string obtained as a result of the replacement to the sound processing section 41 of the rule synthesizing section 4.

When the sound processing section 41 is supplied with the phonogram string from the language processing section 1, it instructs the searching section 42 to search for the waveform of the fragment that forms a phoneme represented by the phonogram for each of the phonogram included in the phonogram string. The sound processing section 41 supplies the phonogram string to the prosody predicting section 52 of the speech piece editing section 5.

In response to the instruction, the searching section 42 searches the waveform database 44 for the compressed waveform data that matches what the instruction says. Then, it supplies the searched out compressed waveform data to the expanding section 43.

The expanding section 43 restores fragment waveform data before compression from the compressed waveform data supplied from the searching section 42 and returns the restored waveform data to the searching section 42. The searching section 42 supplies the fragment waveform data returned from the expanding section 43 to the sound processing section 41 as a result of searching.

On the other hand, the prosody predicting section 52 supplied with the phonogram string from the sound processing section 41 creates prosody predicting data representing the prediction result of the prosody of the speech represented by the phonogram string by performing analysis based on the same prosody predicting method as the speech piece editing section 5 performs in the first embodiment, for example. Then, it supplies the prosody predicting data to the sound processing section 41.

When the sound processing section 41 is supplied with the fragment waveform data from the searching section 42 and also supplied with the prosody predicting data from the prosody predicting section 52, it creates speech waveform data that represents a speech waveform represented by each of the phonogram included in the phonogram string supplied by the language processing section 11 using the fragment waveform data.

Specifically, the sound processing section 41 identifies the time length of the phoneme including fragments represented by each piece of the fragment waveform data supplied by the searching section 42 based on the prosody predicting data supplied by the prosody predicting section 52. Then, the sound processing section 41 only needs to obtain an integer which is the nearest to the value of the identified time length of the phoneme divided by the time length of the fragment represented by the fragment waveform data, and create the speech waveform data by combining pieces of the fragment waveform data by the number of the obtained integer with each other.

The sound processing section 41 may make the speech represented by the speech waveform data have a stress, intonation and the like that match the prosody indicated by the prosody predicting data not only by deciding the time length of the speech represented by the speech waveform data based on the prosody predicted data but also by processing the fragment waveform data included in the speech waveform data.

Then, the sound processing section 41 supplies the created speech waveform data to the output synthesizing section 53 in the speech piece editing section 5 in the order of the phonograms arranged in the phonogram string supplied by the language processing section 1.

When the output synthesizing section 53 is supplied with the sound waveform data from the sound processing section 41, it combines the pieces of the speech waveform data with each other in the order that are supplied from the sound processing section 41 and outputs them as the synthesized sound data. The synthesized sound that is synthesized based on the free text data corresponds to the speech synthesized in the rule synthesizing method.

The method for the output synthesizing section 53 to output the synthesized speech data is also the same as that taken in the speech piece editing section 5 of the first embodiment and is arbitrarily. Therefore, it may play the synthesized speech represented by the synthesized speech data via the D/A converter or the speaker (not shown), for example. It may also send out the synthesized speech data to an external device or a network via an interface circuit (not shown) or may write it to the recording medium that is set in the recording medium drive device (not shown) via the recording medium drive device. The processor that is performing the function of the output synthesizing section 53 may pass the synthesized speech data to the other processing executed by the processor.

Assuming that the sound processing section 41 obtain virtually the same distributed character string as that in the first embodiment. (The sound processing section 41 may take any method to obtain the distributed character string. It may obtain the distributed character string in the same method as the language processing section 1 obtains the free text data, for example.)

In such a case, the sound processing section 41 treats the phonogram string represented by the distributed character string as the phonogram string supplied from the language processing section 1. As a result, the compressed waveform data representing the fragment that forms the phoneme represented by the phonogram included in the phonogram string represented by the distributed character string is searched out by the searching section 42 and the fragment waveform data before the compression is restored by the expanding section 43. On the other hand, the prosody predicting section 52 performs analysis based on the prosody predicting method on the phonogram string represented by the distributed character string. As a result, the prosody predicting data representing the prediction result on the prosody of the speech represented by the phonogram string is created. Then, the sound processing section 41 creates the speech waveform data that represents the waveform of the speech represented by each phonogram included in the phonogram string represented by the distributed character string data based on each piece of the restored fragment waveform data and the prosody predicting data. The output synthesizing section 53 combines the created speech waveform data in the order of the phonograms arranged in the phonogram string represented by the distributed character string data and outputs it as the synthesized speech data. The synthesized speech data that is synthesized based on the distributed character string data also represents the speech synthesized in the rule synthesizing method.

Next, assuming that the matching speech piece deciding section 51 of the speech piece editing section 5 obtains virtually the same standard-size message data, utterance speed data and matching level data as those in the first embodiment. (The matching speech piece deciding section 51 may obtain the standard-size message data, the utterance speed data and the matching level data in any method. For example, it may obtain the standard-size message data, the utterance speed data and the matching level data in the same method as the language processing section 1 obtains the free text data.)

When the standard-size message data, the utterance speed data and the matching level data are supplied to the matching speech piece deciding section 51, the matching speech piece deciding section 51 instructs the searching section 6 to search the compressed speech piece data, corresponding to which the phonogram matching the phonogram representing the reading of the speech piece included in the standard-size message.

In response to the instruction from the matching speech piece deciding section 51, the searching section 6 searches the speech piece database 7 as the searching section 6 does in the first embodiment for all of the corresponding compressed speech piece data, the abovementioned speech piece reading data that is associated with the corresponding compressed speech piece data, the speed default value data and the pitch component data and supplies the searched out compressed waveform data to the expanding section 43. On the other hand, if there is some speech pieces for which the compressed speech piece data can not searched out, the missing part identifying data for identifying the corresponding speech piece is created.

The expanding section 43 restores the speech piece data before the compression from the compressed speech piece data supplied from the searching section 6 and returns it to the searching section 6. The searching section 6 supplies the speech piece data returned from the expanding section 43, and the speech piece reading data, the speed default value data and the pitch component data that are searched out to the speech speed converting section 9 as a searching result. If the missing part identifying data is created, the missing part identifying data is also supplied to the speech speed converting section 9.

On the other hand, the matching speech piece deciding section 51 instructs the speech speed converting section 9 to convert the speech piece data supplied to the speech speed converting section 9 so that the time length of the speech piece represented by the speech piece data matches the speed indicated by the utterance speed data.

In response to the instruction of the matching speech piece deciding section 51, the speech speed converting section 9 converts the speech piece data supplied by the searching section 6 to match with the instruction and supplies it to the matching speech piece deciding section 51. Specifically, it only needs to make the number of samples of the entire speech piece data to the time length that matches the speed instructed by the matching speech piece deciding section 51 by adjusting the length of the section as it separates the speech piece data supplied from the searching section 6 into sections representing respective phonemes, identifies a part representing the fraction forming the phoneme represented by the section from the section for the obtained respective sections, copies the identified part (one or more parts) and inserts it in the section, or removes the part (one or more parts) from the section. The speech speed converting section 9 only needs to decide for respective sections the number of parts representing the fragment to be inserted or removed so that the ratio of the time length between the phonemes represented by respective sections is left virtually the same. Accordingly, the speech can be adjusted more finely than in the case where the phonemes are simply combined and synthesized.

The speech speed converting section 9 also supplies the speech piece reading data and the pitch component data supplied from the searching section 6 to the matching speech piece deciding section 51. If the missing part identifying data is supplied from the searching section 6, the speech speed converting section 9 further supplies the missing part identifying data to the matching speech piece deciding section 51.

If the utterance speed data is not supplied to the matching speech piece deciding section 51, the matching speech piece deciding section 51 only needs to instruct the speech speed converting section 9 to supply the speech piece data supplied to the speech speed converting section 9 to the matching speech piece deciding section 51 without converting the speech piece data and the speech speed converting section 9 only needs to supply the speech piece data supplied from the searching section 6 to the matching speech piece deciding section 51 as it is in response to the instruction. If the number of samples of the speech piece data supplied to the speech speed converting section 9 has matched the time length that matches the speed instructed by the matching speech piece deciding section 51, the speech speed converting section 9 only needs to supply the speech piece data to the matching speech piece deciding section 51 as it is without any conversion.

When the matching speech piece deciding section 51 is supplied with the speech piece data, the speech piece reading data and the pitch component data from the speech speed converting section 9, it selects a speech piece data representing a waveform that can be approximated to the waveform of the speech piece forming a standard-size message from the speech piece data supplied to the matching speech piece deciding section 51 by a piece of the speech piece data for one speech piece as the speech piece editing section 5 in the first embodiment does according to the conditions corresponding to the value of the matching level data.

Here, if there is a speech piece for which speech piece data that satisfies the conditions corresponding to the value of the matching level data that cannot be selected from the speech piece data supplied by the speech speed converting section 9, the matching speech piece deciding section 51 decides to treat the corresponding speech piece as the speech piece for which the searching section 6 cannot search out the compressed speech piece data (i.e., the speech piece indicated by the abovementioned missing part identifying data).

Then, the matching speech piece deciding section 51 determines whether a ratio of the number of characters of the phonogram string that represents the reading of the speech piece which is selected by the speech piece data representing the waveform that can be approximated to the total number of characters of the phonogram string that forms the standard-size message data (or, a ratio of the parts other than the part representing the reading of the speech piece that is indicated by the missing part identifying data supplied by the speech speed converting section 9 to the total number of characters of the phonogram string that forms the standard-size data) reaches a predetermined threshold or not as the speech piece editing section 5 in the first embodiment does.

Then, if it is determined that the abovementioned ratio has reached the threshold, the matching speech piece deciding section 51 supplies the selected speech piece data to the output synthesizing section 53 as the data satisfying the conditions corresponding to the values of the matching level data. In such a case, if the matching speech piece deciding section 51 is also supplied with the missing part identifying data from the speech speed converting section 9, or if there is a speech piece for which no speech piece data that satisfies the conditions corresponding to the value of the matching level data cannot be selected, the matching speech piece deciding section 51 extracts the phonogram string representing the reading of the speech piece indicated by the missing part identifying data (including the speech piece for which no speech piece data that satisfies the conditions corresponding to the value of the matching level data cannot be selected) from the standard-size message data and supplies it to the sound processing section 41, instructing it to synthesize the waveform of the speech piece.

The instructed sound processing section 41 treats the phonogram string supplied from the matching speech piece deciding section 51 as the phonogram string represented by the distributed character string. As a result, the searching section 42 searches out the compressed waveform data representing the fragment that forms the phoneme represented by the phonogram included in the phonogram string, and the fragment waveform data before the compression is restored by the expanding section 43. On the other hand, the prosody predicting section 52 creates the prosody predicting data representing the prediction result of the prosody of the speech piece that is represented by the phonogram string. Then, the sound processing section 41 creates the speech waveform data representing the waveform of the speech represented by respective phonogram included in the phonogram string based on the respective restored fragment waveform data and the prosody predicting data, and supplies the created speech waveform data to the output synthesizing section 53.

The matching speech piece deciding section 51 may supply a part corresponding to the speech piece indicated by the missing part identifying data among the prosody predicting data that has been created by the prosody predicting section 52 and supplied to the matching speech piece deciding section 51 to the sound processing section 41. In such a case, the sound processing section 41 needs not to cause the prosody predicting section 52 to perform prosody prediction on the speech piece again. That enables utterance in more natural way than in the case where the prosody prediction is performed by such a fine unit as a speech piece.

On the other hand, if it is determined that the abovementioned ratio has not reached the threshold, the matching speech piece deciding section 51 decides not to use the speech piece data in speech synthesis, and supplies the entire phonogram string that forms the standard-size message data to the sound processing section 41, instructing to synthesize the waveform of the speech piece.

The instructed sound processing section 41 treats the phonogram string supplied from the matching speech piece deciding section 5 as the phonogram string represented by the distributed character string data. As a result, the sound processing section 41 supplies the speech waveform data representing the waveform of the speech indicated by the phonogram included in the phonogram string to the output synthesizing section 53.

When the speech waveform data that is generated by the fragment waveform data is supplied from the sound processing section 41 and the speech piece data is supplied from the matching speech piece deciding section 51, the output synthesizing section 53 adjusts the number of pieces of the fragment waveform data included in the respective pieces of the supplied speech waveform data to match the time length of the speech represented by the speech waveform data with the utterance speed of the speech piece represented by the speech piece data supplied from the matching speech piece deciding section 51.

Specifically, the output synthesizing section 53 only needs to identify a ratio of the time length of the phoneme represented by each of the abovementioned sections included in the speech piece data to the original time length which was increased or decreased by the matching speech piece deciding section 51 and increase or decrease the number of pieces of the fragment waveform data in each of the speech waveform data so that the time length of the phoneme represented by the speech waveform data supplied from the sound processing section 41 changes in the ratio. For the purpose of identifying the ratio, the output synthesizing section 53 only needs to obtain the original speech piece data used in creating the speech piece data supplied by the matching speech piece deciding section 51 from the searching section 6 and identify the sections representing the same phoneme with each other between the two pieces of speech piece data one by one. Then, it only needs to identify the ratio of the number of fragments included in the section identified in the speech piece data that is supplied by the matching speech piece deciding section 51 increased or deceased against the number of the fragment included in the section that is identified in the speech piece data obtained from the searching section 6 as a ratio of the time length of the phoneme increased or decreased.

If the time length of the phoneme represented by the speech waveform data has been aligned to the speed of the speech piece represented by the speech piece data supplied by the matching speech piece deciding section 51, or if there is no speech piece data that is supplied from the matching speech piece deciding section 51 to the output synthesizing section 53 (specifically, the abovementioned ratio has not reached the threshold or if no speech piece data is selected, for example), the output synthesizing section 53 needs not to adjust the number of the fragment waveform data in the speech waveform data.

Then, the output synthesizing section 53 combines the speech waveform data for which the number of pieces of the fragment waveform data has been adjusted and the speech piece data supplied from the matching speech piece deciding section 51 in the order of the speech pieces and phonemes arranged in the standard-size message indicated by the standard-size message data with each other and outputs it as data representing the synthesized sound.

If the data supplied from the speech speed converting section 9 does not include the missing part identifying data, it only needs to combine the speech piece data selected by the speech piece editing section 5 in the order of phonograms arranged in the phonogram string in the standard-size message indicated by the standard-size message data, and output it as data representing the synthesized data immediately without instructing the sound processing section 41 to synthesize the waveforms.

In the abovementioned speech synthesis system of the second embodiment of the present invention, pieces of the speech piece data representing the waveform of the speech piece which might be a unit bigger than the phoneme are naturally combined with each other in a record editing method based on the prediction result of the prosody and the speech of reading out the standard-size message is synthesized.

On the other hand, the speech piece for which an appropriate speech piece data cannot be selected is synthesized in the rule combining method by using the compressed waveform data representing the fragment, which is a unit smaller than the phoneme. As the compressed waveform data represents the waveform of the fragment, the storage capacity of the waveform database 44 can be smaller than that in the case where the compressed waveform data represents the waveform of the phoneme and can be quickly searched. Therefore, the speech synthesis system can be lighter and more compact and catch up with the quick processing.

The case in which the rule synthesizing is performed by using the fragment differs from the case in which rule synthesizing is performed by using the phoneme in that the speech synthesis can be performed without being affected by a special waveform that appears in the part at the end of the phoneme. Therefore, the first case can produce natural speech with a few kinds of fragments.

That is, it is known that a special waveform which is affected by both of the preceding phoneme and the following phoneme appears in the boundary on which the preceding phoneme transfers to the following phoneme in the speech uttered by a human being. On the other hand, the phoneme used in the rule synthesizing has included the special waveform at the end when it is collected. Therefore, if the rule synthesizing is performed by using the phoneme, the great number of kinds of phonemes need to be prepared for enabling to reproduce various patterns of waveform on the boundary between the phonemes, or it should be satisfied by synthesizing the synthesized speech that differs from the speech whose waveform on the boundary between the phonemes is natural. In the case in which the rule synthesizing is performed by using the fragment, affection caused by a special waveform on the boundary between the phonemes can be removed in advance by collecting the fragment from parts other than the ends of the phoneme. Accordingly, it can produce natural speech without requiring preparing the great number of kinds of phonemes.

In the case in which a ratio of the speech piece which can be approximated by the speech piece represented by the speech piece data in the entire speech pieces forming the standard-size message has not reached the abovementioned threshold, the speech synthesis system also performs the speech synthesis in the rule synthesizing method for the entire of the standard-size messages without using the speech piece data representing the speech piece which can be approximated in the speech synthesis. Accordingly, even if the standard-size message has a few speech pieces which can be approximated by the speech piece represented by the speech piece data, the quality in the speech pieces in the synthesized speech has not so outstanding unevenness, providing little abnormality.

The configuration of the speech synthesis system of the second embodiment of the present invention is not limited to that mentioned above.

For example, the fragment waveform data needs not to be the PCM format data and may have any data format. The waveform database 44 needs not to store the fragment waveform data or the speech piece data in a state of being subjected to the data compression. If the waveform database 44 stores the fragment waveform data in a state of not being subjected to the data compression, the unit body M2 needs not to have the expanding section 43.

The waveform database 44 needs not to store the waveform of the fragment in a separated state. It may store the waveform of the speech formed by a plurality of fragments and the data for identifying the location where individual fragments are present in the waveform, for example. In such a case, the speech piece database 7 may perform the function of the waveform database 44.

The matching speech piece deciding section 51 previously stores the prosody register data; and if the particular speech piece is included in, the standard-size message, it may treat the prosody represented by the prosody register data as a result of the prosody prediction, as the speech piece editing section 5 of the first embodiment does. Alternatively, the matching speech piece deciding section 51 may store the result of the past prosody prediction as the prosody register data anew.

The matching speech piece deciding section 51 may obtain the free text data or the distributed character string data, select the speech piece data representing the waveform that is near the waveform of the speech piece included in the free text or the distributed character string represented by them by performing virtually the same processing as that for selecting the speech piece data representing the waveform near the waveform of the speech piece included in the standard-size message and use them in the speech synthesis as the speech piece editing section 5 of the first embodiment does. In such a case, the sound processing section 41 needs not to cause the searching section 42 to search for the waveform data representing the waveform of the speech piece for the speech piece represented by the speech piece data selected by the matching speech piece deciding section 51. The matching speech piece deciding section 51 may report the speech piece the sound processing section 41 needs not to synthesize to the sound processing section 41, and the sound processing section 41 may stop the searching of the waveform of the unit speech that forms the speech piece in response to the report.

The compressed waveform data stored by the waveform database 44 needs not to represent the fragment, and may be waveform data that represents the waveform of the unit speech represented by the phonogram stored by the waveform database 44 or data obtained when the entropy coding is performed on the waveform data as in the first embodiment, for example.

The waveform database 44 may store both of the data representing the waveform of the fragment and the data representing the waveform of the phoneme. In such a case, the sound processing section 41 may cause the searching section 42 to search for the phoneme represented by the phonogram included in the distributed character string and the like, and causes the searching section 42 to search for the data representing the fragment that forms the phoneme represented by the phonogram as for the phonogram for which no corresponding phoneme is searched out, and causes the searching section 42 to create the data representing the phoneme by using the searched out data representing the fragment.

The speech speed converting section 9 may use any method for matching the time length of the speech piece represented by the speech piece data with the speed indicated by the utterance speed data. Therefore, the speech speed converting section 9 may resample the speech piece data supplied by the searching section 6 and increase or decrease the number of the samples of the speech piece data to match the number corresponding to the time length that matches the utterance speed instructed by the matching speech piece deciding section 51 as the processing in the first embodiment.

The unit body M2 needs not to include the speech speed converting section 9. If the unit body M2 does not have the speech converting section 9, the prosody predicting section 52 may predict the utterance speed, and the matching speech piece deciding section 51 may select the speech piece data whose utterance speed matches the result of the prediction by the prosody predicting section 52 under predetermined conditions for determination among the speech piece data obtained by the searching section 6 and eliminate the speech piece data whose utterance speed does not match the result of the prediction from objects of selection. The speech piece database 7 may store a plurality of speech piece data with the same reading and different utterance speed.

The output synthesizing section 53 may use any method for matching the time length of the phoneme represented by the speech waveform data with the utterance speed of the speech piece represented by the speech piece data. Therefore, the output synthesizing section 53 may identify the ratio of the time length of the phoneme represented by each section included in the speech piece data increased or decreased by the matching speech piece deciding section 51 to the original time length, and then re-sample the speech waveform data, and increase or decrease the number of samples of the speech waveform data to the number corresponding to the time length that matches the utterance speed identified by the matching speech piece deciding section 51.

The utterance speed may be different for each speech piece. (Therefore, the utterance speed data may be that for specifying the utterance speed different for each speech piece.) Then, the output synthesizing section 53 may decide the utterance speed of the speech between the two speech pieces by interpolating the utterance speed of the two speech pieces (for example, linear interpolation) and convert the speech waveform data, which represents the speech, to match the decided utterance speed, for the speech waveform data of each speech with the different utterance speed which is placed between two speech pieces.

The output synthesizing section 53 may convert the speech waveform data returned from the sound processing section 41 to match the time length of the speech with the speed identified by the utterance speed data supplied to the matching speech piece deciding section 51 for example, even if the speech waveform data represents the speech that forms the speech that reads up the free text or the distributed character string.

In the abovementioned system, the prosody predicting section 52 may perform prosody prediction (including the prediction of the utterance speed) for the entire sentence, or perform prosody prediction by a predetermined unit. If there is a speech piece with the same reading when the prosody prediction is performed on the entire sentence, it further determines whether the prosody matches within predetermined conditions or not. If the reading matches, the speech piece may be adopted. For the part in which the same speech piece is not present, the rule synthesizing section 4 may produce the speech based on the fragment. In such a case, the pitch or the speed of the part to be synthesized based on the fragment may be adjusted based on the result of prediction on the prosody that is performed for the entire sentences or by a predetermined unit. That enables natural speech even if the speech piece and the speech produced based on the fragment are combined to be synthesized.

If the character string input into the language processing section 1 is the phonogram string, the language processing section 1 may perform a well-known natural language analysis processing other than the prosody prediction and the matching speech piece deciding section 51 may select the speech piece based on the result of the natural language analysis processing. That enables selection of the speech piece by using the result of analyzing the character string for each word (the part of speech such as the noun, the verb), which leads the speech more natural than in the case where a speech piece that matches the phonogram string is simply selected.

In the first and the second embodiments, the object to be compared with the threshold needs not to be the number of characters. For example, whether a ratio of the number of actually searched out speech pieces against the total number of the speech pieces to be searched out reached a predetermined threshold or not may be determined.

Although the embodiments of the present invention have been described, the speech synthesis device according to the present invention can be implemented by a usual computer system without a dedicated system.

For example, the unit body M1 for performing the abovementioned processing may be configured as programs for causing a personal computer to perform operations of the abovementioned language processing section 1, the general word dictionary 2, the user word dictionary 3, the sound processing section 41, the searching section 42, the expanding section 43, the waveform database 44, the speech piece editing section 5, the searching section 6, the speech piece database 7, the expanding section 8 and the speech speed converting section 9 are installed from the recording media (CD-ROM, MO, a floppy (registered trademark) disk and the like) that is storing the program.

The speech piece register unit R for performing the abovementioned processing may be configured as programs for causing a personal computer to perform operations of the abovementioned recorded speech piece data set storing section 10, the speech piece database creating section 11 and the compressing section 12 are installed from the recording media that is storing the program.

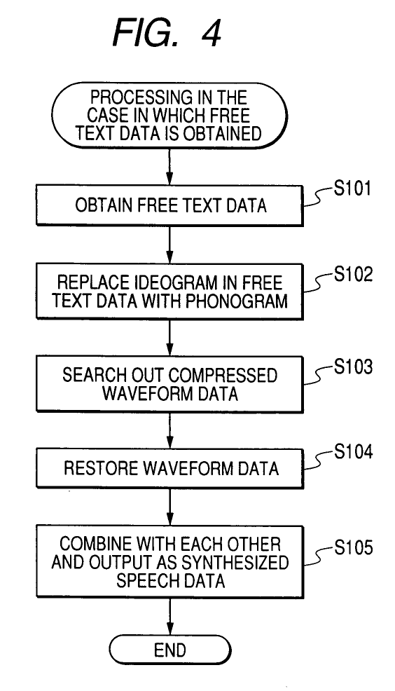

Then, it is assumed that the personal computer, which functions as the unit body M1 or the speech piece register unit R by executing the programs, performs the processing shown in FIG. 4 to FIG. 6 as the processing corresponding to the operations of the speech synthesis system of FIG. 1.

FIG. 4 is a flowchart showing the processing in the case in which a personal computer obtains the free text data.

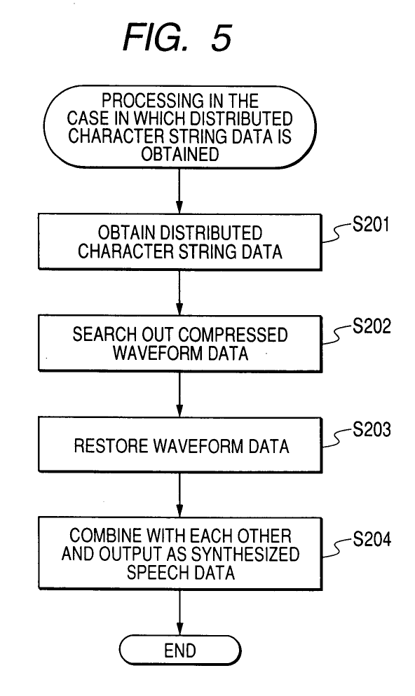

FIG. 5 is a flowchart showing the processing in the case in which the personal computer obtains the distributed character string data.

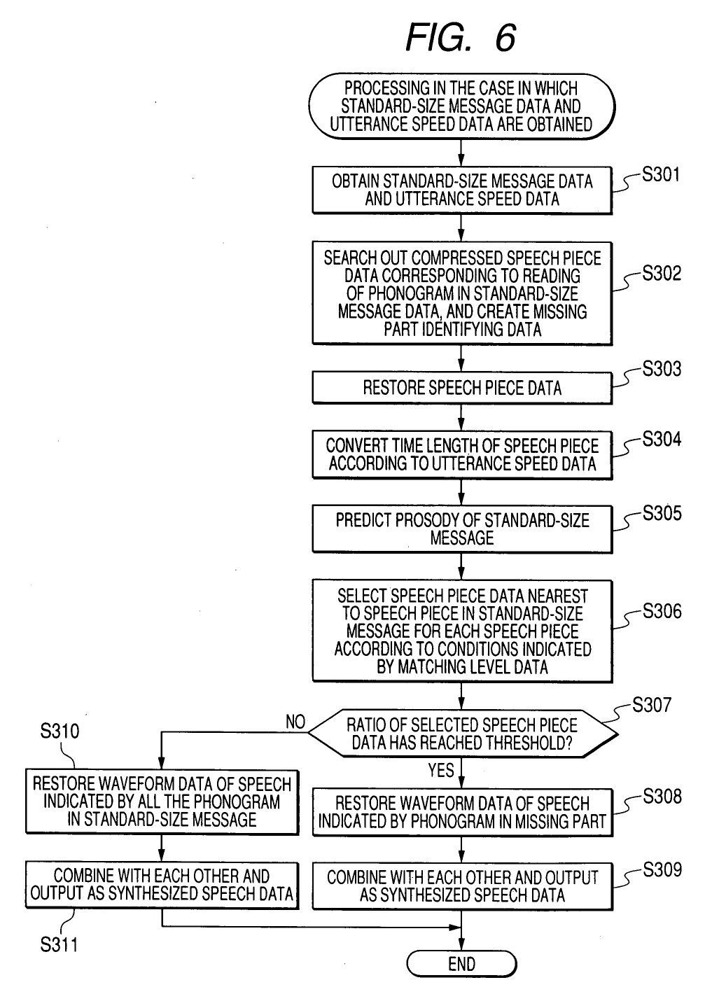

FIG. 6 is a flowchart showing the processing in the case in which the personal computer obtains the standard-size message data and the utterance speed data.

That is, when the personal computer obtains the abovementioned free text data from outside (step S101, FIG. 4), it identifies the phonogram representing the reading of each ideogram included in the free text represented by the free text data by searching the general word dictionary 2 or the user word dictionary 3 for the phonogram and replaces the ideogram with the identified phonogram (step S102). The personal computer may obtain the free text data in any method.

When the phonogram string that represents the result of replacing all the ideograms in the free text with the phonograms is obtained, the personal computer searches the waveform database 44 for the waveform of the unit speech represented by the phonogram about each phonogram included in the phonogram string, and searches out the compressed waveform data that represents the waveform of the unit speech represented by each phonogram included in the phonogram string (step S103).

Then, the personal computer restores the waveform data before the compression from the searched out compressed waveform data (step S104), combines the pieces of the restored waveform data with each other in the order of the phonograms arranged in the phonogram string, and outputs it as the synthesized speech data (step S105). The personal computer may output the synthesized speech data in any method.

When the personal computer obtains the abovementioned distributed character string data from outside in an arbitrary method (step S201, FIG. 5), it searches the waveform database 44 for the waveform of the unit speech represented by the phonogram about each phonogram included in the phonogram string represented by the distributed character string, and searches out the compressed waveform data that represents the waveform of the unit speech represented by each phonogram included in the phonogram string (step S202).

Then, the personal computer restores the waveform data before the compression from the searched out compressed waveform data (step S203), combines the pieces of the restored waveform data with each other in the order of the phonograms arranged in the phonogram string, and outputs it as the synthesized speech data in the same processing as that at the step S105 (step S204).

When the personal computer obtains the abovementioned standard-size message data and the utterance speed data from outside in an arbitrary method (step S301, FIG. 6), it first searches out all the compressed speech piece data, with which the phonogram that matches the phonogram representing the reading of the speech piece included in the standard-size message that is represented by the standard-size message data is associated (step S302).

At the step S302, it also searches out the speech piece reading data, the speed default value data, and the pitch component data that are associated with the corresponding compressed speech piece data. If a plurality of pieces of the compressed speech piece data correspond to a speech piece, it searches out all pieces of the corresponding compressed speech piece data. On the other hand, if there is a speech piece for which no compressed speech piece data is searched out, it produces the abovementioned missing part identifying data.

Then, the personal computer restores the speech piece data before the compression from the searched out compressed waveform data (step S303). Then, it converts the pieces of the restored speech piece data in the same processing as that performed by the abovementioned speech piece editing section 5 to match the time length of the speech piece represented by the speech piece data with the speed indicated by the utterance speed data (step S304). If no utterance speed data is supplied, it needs not to convert the restored speech piece data.

Then, the personal computer predicts the prosody of the standard-size message by performing analysis based on the prosody predicting method on the standard-size message represented by the standard-size message data (step S305). Then, it selects a piece of speech piece data representing the waveform nearest to the waveform of the speech piece that forms the standard-size message from the speech piece data, whose time length of the speech piece is converted, by a piece of speech piece data for a speech piece, according to a standard indicated by the matching level data obtained from outside by performing the same processing as that performed by the abovementioned speech piece editing section 5 (step S306).

Specifically, at the step S306, the personal computer identifies the speech piece data according to the abovementioned conditions (1) to (3), for example. That is, it is assumed that if the value of the matching level data is “1”, all pieces of the speech piece data whose reading matches with that of the speech piece in the standard-size message are considered to represent the waveform of the speech piece in the standard-size message. As far as the phonogram representing the reading matches and the contents of the pitch component data representing the chronological change of the frequency of the pitch component of the speech piece data matches the prediction result of the accent of the speech piece included in the standard-size message if the value of the matching level data is “2”, it is considered as the speech piece data represents the waveform of the speech piece in the standard-size message. As far as the phonogram representing the reading and the accent match and determination on whether the speech represented by the speech piece data is uttered as nasal consonant or a voiceless consonant or not matches with the prediction result of the prosody of the standard-size message if the value of the matching level data is “3”, it is considered as the speech piece data represents the waveform of the speech piece in the standard-size message.

If there are a plurality of pieces of the speech piece data that match the standard indicated by the matching level data for a speech piece, it is assumed that the plurality of pieces of the speech piece data are narrowed to one piece according to conditions stricter than those set.

Then, the personal computer determines whether a ratio of the number of characters in the phonogram string, each of which represents the reading of the speech piece whose speech piece data is selected at the step S306, to the total number of the characters in the phonogram string that forms the standard-size message data (or, a ratio of the part other than the part representing the reading of the speech piece indicated by the missing part identifying data created at the step S302 to the total number of characters in the phonogram string that forms the standard-size message data) has reached a predetermined threshold or not (step S307).

If it is determined that the abovementioned ratio has reached the threshold and as far as the personal computer has created the missing part identifying data at the step S302, the personal computer restores the waveform data representing the waveform of the speech indicated by each phonogram in the phonogram string by extracting the phonogram string representing the reading of the speech piece indicated by the missing part identifying data from the standard-size message data and performing the processing at the abovementioned steps S202 to S203 with the extracted phonogram string treated in the same manner as the phonogram string represented by the distributed character string data for each phoneme for the phonogram string (step S308).

Then, the personal computer combines the restored waveform data with the speech piece data selected at the step S306 in the order of the phonograms arranged in the phonogram string in the standard-size message indicated by the standard-size message data and output it as the data representing the synthesized speech (step S309).

On the other hand, if it is determined that the abovementioned ratio has not reached the threshold at the step S307, the personal computer restores the waveform data representing the waveform of the speech indicated by each phonogram in the phonogram string by deciding not to use the speech piece data in speech synthesis and performing the processing at the abovementioned steps S202 to S203 with the extracted phonogram string treated in the same manner as the phonogram string represented by the distributed character string data for each phoneme for the entire of the phonogram string that forms the standard-size message data (step S310). Then, it combines the pieces of the restored waveform data in the order of the phonograms arranged in the phonogram string in the standard-size message indicated by the standard-size message data and outputs it as the data representing the synthesized speech (step S311).

For example, the unit body M2 for performing the abovementioned processing may be configured as programs for causing a personal computer to perform operations of the language processing section 1, the general word dictionary 2, the user word dictionary 3, the sound processing section 41, the searching section 42, the expanding section 43 and the waveform database 44, the speech piece editing section 5, the searching section 6, the speech piece database 7, the expanding section 8 and the speech speed converting section 9 of FIG. 3 are installed from the recording media that is storing the program.

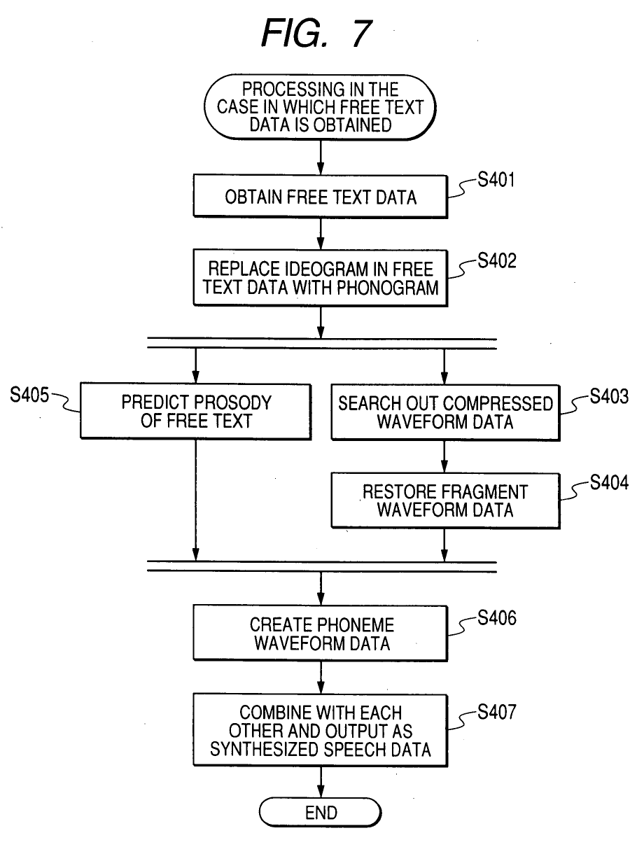

Then, it is assumed that the personal computer, which functions as the unit body M2 by executing the programs, can perform the processing shown in FIG. 7 to FIG. 9 as the processing corresponding to the operations of the speech synthesis system of FIG. 3.

FIG. 7 is a flowchart showing the processing in the case in which a personal computer that performs the functions of the unit body M2 obtains the free text data.

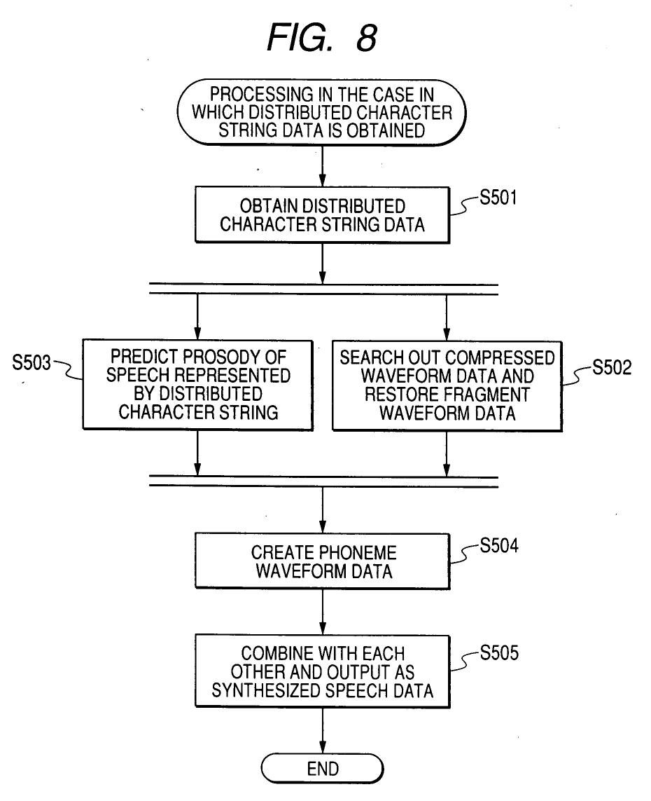

FIG. 8 is a flowchart showing the processing in the case in which the personal computer that performs the functions of the unit body M2 obtains the distributed character strings.

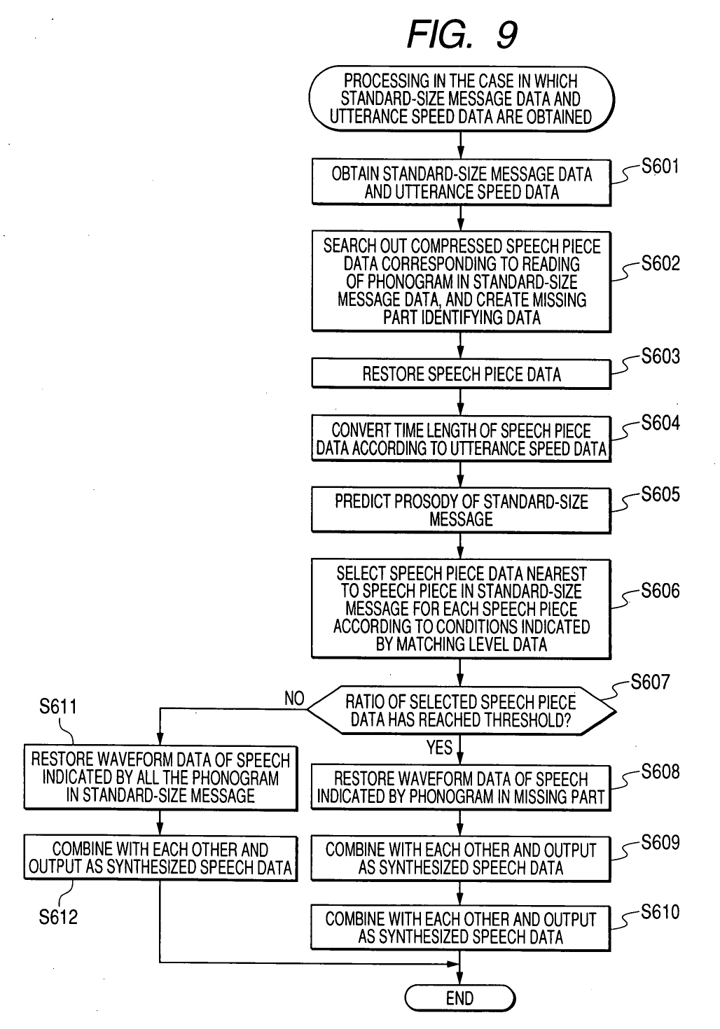

FIG. 9 is a flowchart showing the processing in the case in which the personal computer that performs the functions of the unit body M2 obtains the standard-size message data and the utterance speed data.

That is, when the personal computer obtains the abovementioned free text data from outside (step S401, FIG. 7), it identifies the phonogram representing the reading of each ideogram included in the free text represented by the free text data by searching the general word dictionary 2 or the user word dictionary 3 for the phonogram and replaces the ideogram with the identified phonogram (step S402). The personal computer may obtain the free text data in any method.

When the phonogram string that represents the result of replacing all the ideograms in the free text with the phonograms is obtained, the personal computer searches the waveform database 44 for the waveform of the unit speech represented by the phonogram about each phonogram included in the phonogram string, and searches out the compressed waveform data that represents the waveform of the fragment that forms the phoneme represented by each phonogram included in the phonogram string (step S403), and restores the fragment waveform data before the compression from the searched out compressed waveform data (step S404).

On the other hand, when the personal computer predicts the prosody of the speech represented by the free text by performing analysis based on the prosody predicting method on the free text data (step S405). Then, it creates the fragment waveform data restored at the step S404 and the speech waveform data based on the prediction result of the prosody at the step S405 (step S406), combines the pieces of the obtained speech waveform data with each other in the order of the phonograms arranged in the phonogram string, and outputs it as the synthesized speech data (step S407). The personal computer may output the synthesized speech data in any method.

When the personal computer obtains the abovementioned distributed character string data from outside in an arbitrary method (step S501, FIG. 8), it performs the processing for searching out the compressed waveform data representing the waveform of the fragment that forms the phoneme represented by the phonogram, and the processing for restoring the fragment waveform data from the searched out compressed waveform data for each phonograms included in the phonogram string represented by the distributed character string data as in the abovementioned steps S403 to 404 (step S502).

When the personal computer predicts the prosody of the speech represented by the distributed character strings by performing analysis based on the prosody predicting method on the distributed character string (step S503), it creates the fragment waveform data restored at the step S502 and the speech waveform data based on the prediction result of the prosody at the step S503 (step S504), combines the pieces of the obtained speech waveform data with each other in the order of the phonograms arranged in the phonogram string, and outputs it as the synthesized speech data by the same processing as that taken at the step S407 (step S505).

On the other hand, when the personal computer obtains the abovementioned standard-size message data and the utterance speed data from outside in an arbitrary method (step S601, FIG. 9), it first searches out all the pieces of the compressed speech piece data with which phonograms that match the phonograms representing the reading of the speech piece included in the standard-size message represented by the standard-size message data are associated (step S602).

At the step S602, it also searches out the abovementioned speech piece reading data that is associated with the corresponding compressed speech piece data, the speed default value data and the pitch component data. If a plurality of pieces of the compressed speech piece data correspond to a speech piece, all the pieces of corresponding compressed speech piece data are searched. On the other hand, if there is a speech piece for which no compressed speech piece data is searched out, it produces the abovementioned missing part identifying data.

Then, the personal computer restores the fragment speech piece data before the compression from the searched out compressed speech piece data (step S603). It converts the restored speech piece data by the same processing as that performed by the abovementioned output synthesizing section 53 to match the time length of the speech piece represented by the speech piece data with the speed identified by the utterance speed data (step S604). If no utterance speed data is supplied, the restored speech piece data needs not to be converted.

Then, the personal computer predicts the prosody of the standard-size message by performing analysis based on the prosody predicting method on the standard-size message represented by the standard-size message data (step S605). Then, it selects a piece of speech piece data representing the waveform nearest to the waveform of the speech piece that forms the standard-size message from the speech piece data, whose time length of the speech piece is converted, by a piece of speech piece data for a speech piece, according to a standard indicated by the matching level data obtained from outside by performing the same processing as that performed by the abovementioned matching speech piece deciding section 51 (step S606).

Specifically, the personal computer identifies the speech piece data according to the abovementioned conditions (1) to (3), for example, by performing the same processing as that taken at the abovementioned step 306 at the step S606. It is assumed that if there are a plurality of pieces of the speech piece data that match the standard indicated by the matching level data for a speech piece, it narrows the plurality of pieces of speech piece data into a piece according to the condition stricter than the set conditions. It is also assumed that if there is a speech piece for which no speech piece data that satisfies the conditions corresponding to the value of the matching level data, it decides to treat the corresponding speech piece as the speech piece, for which no compressed speech piece data is searched out, and creates the missing part identifying data, for example.

Next, the personal computer determines whether a ratio of the number of characters of the phonogram string representing the reading of the speech piece for which the speech piece data representing the waveform that can be approximated is selected to the total number of characters of the phonogram string forming the standard-size message data (or, a ratio of the part other than the part representing the reading of the speech piece indicated by the missing part identifying data created at the step S602 or S606 to the total number of characters in the phonogram string that forms the standard-size message data) has reached a predetermined threshold or not as the matching speech piece deciding section 53 of the second embodiment does (step S607).

If it is determined that the abovementioned ratio has reached the threshold and if the personal computer has created the missing part identifying data at the steps S602 or S606, it creates the speech waveform data representing the waveform of the speech indicated by each phonogram in the phonogram character string by extracting the phonogram string representing the reading of the speech piece indicated by the missing part identifying data from the standard-size message data and performing the same processing as that in the abovementioned steps S502 to S504 with the extracted phonogram string treated as the phonogram string represented by the distributed character string for each phoneme for the extracted phonogram string (step S608).

At the step S608, the personal computer may create the speech waveform data by using the result of the prosody prediction at the step S605 instead of performing the processing corresponding to the processing at the step S503.

Then, the personal computer adjusts the number of pieces of the fragment waveform data included in the speech waveform data created at the step S608 by performing the same processing as that performed by the abovementioned output synthesizing section 53 to match the time length of the speech represented by the speech waveform data with the utterance speed of the speech piece represented by the speech piece data selected at the step S606 (step S609).

That is, the personal computer only needs to identify the ratio of the time length of the phoneme represented by each of the abovementioned sections included in the speech piece data selected at the step S606 increased or decreased to the original time length at the step S609, for example, and increase or decrease the number of pieces of the fragment waveform data in each piece of the speech waveform data so as to change the time length of the speech represented by the speech waveform data created at the step S608 by the ratio. In order to identify the ratio, the personal computer only needs to identify a section which represents the same speech in the speech piece data selected at the step S606 (the speech piece data after the utterance speed conversion) and the original speech piece data which is the speech piece data before being subjected to the conversion at the step S604 by one section for each piece of data, and identify the ratio of the number of the fragments included in the section identified in the original speech piece data after being subjected to the utterance speed conversion increased or decreased to the number of the fragments included in the section identified in the original speech piece data as the ratio of the time length of the speech increased or decreased.

If the time length of the speech represented by the speech waveform data has matched the speed of the speech piece represented by the speech piece data after being subjected to the utterance speed conversion, or if there is no speech piece data selected at the step S606, the personal computer needs not to adjust the number of pieces of the fragment waveform data in the speech waveform data.

Then, the personal computer combines the speech waveform data which has come through the processing at the step S609 and the speech piece data selected at the step S606 with each other in the order of the phonogram string arranged in the standard-size message indicated by the standard-size message data, and outputs it as the data representing the synthesized speech (step S610).

On the other hand, at the step S607, if it determined that the abovementioned ratio has not reached the threshold, the personal computer decides not to use the speech piece data in the speech synthesis, and creates the speech waveform data representing the waveform of the speech indicated by each phonogram in the phonogram string by performing the same processing as those at the abovementioned steps S502 to S504 with the speech piece data treated as the phonogram strings represented by the distributed character string data for each phoneme for the entire phonogram string that forms the standard-size message data (step S611). The personal computer may create the speech waveform data by using the result of the prosody prediction at the step S605 instead of performing the processing corresponding to the processing at the step S503 at the step S611.

Then, the personal computer combines pieces of the speech waveform data created at the step S611 with each other in the order of the phonogram string arranged in the standard-size message indicated by the standard-size message data and outputs it as the data representing the synthesized speech (step S612).

The programs for causing the personal computer to perform the functions of the unit body M2 and the speech piece register unit R may be uploaded on the Bulletin Board (BBS) of the communication circuit and distributed via the communication circuit, for example. Alternatively, it is also possible that a carrier wave is modulated with the signals representing the programs, the obtained modulated wave is transmitted so that the device received the modulated wave restores the programs by demodulating the modulated wave.

Then, the abovementioned processing can be performed when the programs are activated and executed as the other application program under the control of the OS.

If the OS is responsible for a part of the processing or the OS forms a part of a component of the present invention, the recording medium may store the program with the part removed. In the present invention, it is also assumed that the recording medium stores programs for enabling each function or each step to be performed by the computer also in such a case.

1. A speech synthesis device characterized by comprising:
speech piece storing means for storing a plurality of pieces of speech piece data representing a speech piece;
selecting means for inputting sentence information representing a sentence and performing processing for selecting pieces of speech piece data with a common speech and reading that forms said sentence from each piece of said speech piece data;
missing part synthesizing means for synthesizing speech data representing a waveform of the speech for the speech whose speech piece data cannot be selected by said selecting means from the speeches that form said sentence; and
means for creating data representing the synthesized speech by combining the speech piece data selected by said selecting means and the speech data synthesized by said missing part synthesizing means, wherein
said selecting means further includes determining means for determining whether a ratio of the speech with a common speech and reading represented by the selected speech data in the entire speech that forms said sentence has reached a predetermined value or not, and
if it is determined that said ratio has not reached said predetermined value, the selecting means cancels selection of the speech piece data and performs processing as the speech piece data cannot be selected.

2. A speech synthesis device characterized by comprising:
speech piece storing means for storing a plurality of pieces of speech piece data representing a speech piece;
prosody predicting means for inputting sentence information representing a sentence and predicting a prosody of the speech that forms the sentence;
selecting means for performing processing for selecting pieces of speech piece data with common speech and reading whose prosody matches a prosody prediction result under a predetermined conditions that forms said sentence from said speech piece data;
missing part synthesizing means for synthesizing speech data representing a waveform of the speech piece for the speech whose speech piece data cannot be selected by said selecting means from the speeches that form said sentence; and
means for creating data representing the synthesized speech by combining the speech piece data selected by said selecting means and the speech data synthesized by said missing part synthesizing means with each other, wherein
said selecting means further includes determining means for determining whether a ratio of the speech with common speech and reading represented by the selected speech data in the entire speech that forms said sentence has reached a predetermined value or not, and
if it is determined that said ratio has not reached said predetermined value, the selecting means cancels selection of the speech piece data and performs processing as the speech piece data cannot be selected.

3. The speech synthesis device according to claim 2, characterized in that
said selecting means removes the speech piece data whose prosody does not match the prosody predicting result under said predetermined conditions from objects of selection.

4. The speech synthesis device according to claim 2 or 3, characterized in that
said missing part synthesizing means comprises:
storing means for storing a plurality of pieces of data representing a phoneme or representing fragments that form the phoneme; and
synthesizing means for synthesizing the speech data representing the waveform of the speech by identifying a phoneme included in the speech whose speech piece data cannot be selected by said selecting means, obtaining pieces of data representing the identified phoneme or fragments that form the phoneme from said storing means and combining with each other.

5. The speech synthesis device according to claim 4, characterized in that
said missing part synthesizing means comprises:
missing part prosody predicting means for predicting the prosody of said speech whose speech piece data cannot be selected by said selecting means, wherein
said synthesizing means synthesizes the speech data representing the waveform of the speech by identifying the phoneme included in said speech whose speech piece data cannot be selected by said selecting means, by obtaining the data representing the identified phoneme or the fragments that form the phoneme from said storing means, converting the obtained data so that the phoneme or the speech piece represented by the data matches the prediction result of the prosody by said missing part prosody predicting means, and combining the pieces of the converted data with each other.

6. The speech synthesis device according to claims 2 or 3, characterized in that
said missing part synthesizing means synthesizes the speech data representing the waveform of the speech piece for the speech whose speech piece data cannot be selected by said selecting means based on the prosody predicted by said prosody predicting means.

7. The speech synthesis device according to claims 2, 3 or 5, characterized in that
said speech piece storing means stores the prosody data representing the chronological change of the pitch of the speech piece represented by the speech piece data in association with the speech piece data,
wherein said selecting means selects the speech piece data with the common speech and reading that forms said sentences, wherein the chronological change of the pitch represented by the prosody data that is associated with the speech piece data is the nearest to the prediction result of the prosody from each piece of said speech piece data.

8. The speech synthesis device according to claims 1, 2, 3 or 5, characterized in comprising:
speech speed converting means for obtaining speech speed data that specifies conditions of the speed in speaking said synthesized speech and selecting or converting the speech piece data and/or the speech data that form the data representing said synthesized speech so that the speech speed data represents the speech that is spoken at a speed that satisfies the specified conditions.

9. The speech synthesis device according to claim 8, characterized by comprising:
said speech speed converting means converts the speech piece data and/or the speech data so that said speech speed data represents the speech that is spoken at a speed that satisfies the specified conditions by removing a section representing the fragment from the speech piece data and/or the speech data that form the data representing said synthesized speech, or adding the section representing the fragment to the speech piece data and/or the speech data.

10. The speech synthesis device according to claims 1, 2, 3 or 5, characterized in that
said speech piece storing means stores the phonogram data representing the reading of the speech piece data in association with the speech piece data, wherein
said selecting means treats the speech piece data, with which the phonogram data representing the reading that matches the reading of the speech that forms said sentences is associated, as the speech piece data whose reading is in common with the speech.

11. A speech synthesis method characterized by comprising:
a speech piece storing step of storing a plurality of pieces of speech piece data representing a speech piece;
a selecting step of inputting sentence information representing a sentence and performing processing for selecting pieces of speech piece data with common speech and reading that forms said sentence from each piece of the speech piece data;
a missing part synthesizing step of synthesizing speech data representing a waveform of the speech for the speech whose speech piece data cannot be selected from the speech that forms said sentence; and
a step of creating data representing the synthesized speech by combining the selected speech piece data and the synthesized speech data with each other, wherein
said selecting step further includes a determining step of determining whether a ratio of the speech with common speech and reading represented by the selected speech data in the entire speech that forms said sentence has reached a predetermined value or not, and
if it is determined that said ratio has not reached the predetermined value, the selecting step cancels selection of the speech piece data and performs processing as the speech piece data cannot be selected

12. A speech synthesis method characterized by comprising:
a speech piece storing step of storing a plurality of pieces of speech piece data representing a speech piece;
a prosody predicting step of inputting sentence information representing a sentence and predicting a prosody of the speech that forms the sentence;
a selecting step of selecting pieces of speech piece data with common speech and reading whose prosody matches a prosody prediction result under a predetermined conditions that forms said sentence from each piece of said speech piece data;
a missing part synthesizing step of synthesizing speech data representing a waveform of the speech for the speech whose speech piece data cannot be selected from the speeches that form said sentence; and
a step of creating data representing the synthesized speech by combining the selected speech piece data and the synthesized speech data with each other, wherein
said selecting step further includes a determining step of determining whether a ratio of the speech with common speech and reading represented by the selected speech data in the entire speech that forms said sentence has reached a predetermined value or not, and
if it is determined that said ratio has not reached said predetermined value, the selecting step cancels selection of the speech piece data and performs processing as the speech piece data cannot be selected.

13. A program for causing a computer to function as:
speech piece storing means for storing a plurality of pieces of speech piece data representing a speech piece;
selecting means for inputting sentence information representing a sentence and performing processing for selecting pieces of speech piece data with a common speech and reading that forms said sentence from each piece of said speech piece data;
missing part synthesizing means for synthesizing speech data representing a waveform of the speech for the speech whose speech piece data cannot be selected by said selecting means from the speeches that form said sentence; and
means for creating data representing the synthesized speech piece by combining the speech piece data selected by said selecting means and the speech data synthesized by said missing part synthesizing means, characterized in that
said selecting means further includes determining means for determining whether a ratio of the speech with a common speech and reading represented by the selected speech data in the entire speech that forms said sentence has reached a predetermined value or not, and
if it is determined that said ratio has not reached the predetermined value, the selecting means cancels selection of the speech piece data and performs processing as the speech piece data cannot be selected

14. A program for causing a computer to function as:
speech piece storing means for storing a plurality of pieces of speech piece data representing a speech piece;
prosody predicting means for inputting sentence information representing a sentence and predicting a prosody of the speech that forms the sentence;
selecting means for performing processing for selecting pieces of speech piece data with common speech and reading whose prosody matches a prosody prediction result under a predetermined conditions that forms said sentence from said speech piece data;
missing part synthesizing means for synthesizing speech data representing a waveform of the speech piece for the speech whose speech piece data cannot be selected by said selecting means from the speeches that form said sentence; and
means for creating data representing the synthesized speech by combining the speech piece data selected by said selecting means and the speech data synthesized by said missing part synthesizing means with each other, characterized in that
said selecting means further includes determining means for determining whether a ratio of the speech with common speech and reading represented by the selected speech data in the entire speech that forms said sentence has reached a predetermined value or not, and
if it is determined that said ratio has not reached the predetermined value, the selecting means cancels selection of the speech piece data and performs processing as the speech piece data cannot be selected
